(19) United States
(12) Patent Application Publication
(10) Pub. No.: US 2009/0260885 A1
(43) Pub. Date: Oct. 22, 2009

(54) Methods Of Preparing Hydrocarbon, Water And Organophilic Clay Emulsions And Compositions Thereof

(76) Inventor: Daniel Guy Pomerleau, Calgary (CA)

Correspondence Address: ST. ONGE STEWARD JOHNSTON & REENS, LLC, 986 BEDFORD STREET, STAMFORD, CT, 06905-5619, US

(21) Appl. No.: 12/252,852

(22) Filed: Oct. 16, 2008

Related U.S. Application Data
(63) Continuation of application No. PCT/CA2007/000646, filed on Apr. 18, 2008.

(51) Int. Cl. C09K 8/035

(52) U.S. Cl. 175/65; 507/138

(57) ABSTRACT

This invention relates to compositions and methods for improving the performance of organophilic organic-clay complexes, which are dispersible in organic liquids to form a gel therein. Depending on the composition of the gel, such gels may be useful as lubricating greases, oil-based muds, oil base packer fluids, paint-varnish-lacquer removers, paints, foundry molding sand binders, adhesives and sealants, inks, polyester laminating resins, polyester gel coats, cosmetics, detergents, and the like.

### CROSS-REFERENCE TO RELATED APPLICATIONS

The present application is a continuation of pending International patent application PCT/CA2007/000646 filed on Apr. 18, 2008 which designates the United States and claims the benefit under 35 U.S.C. §119 (e) of the U.S. Provisional Patent Application Ser. Nos. 60/745,143 filed on Apr. 19, 2007 and 60/747,152 filed on May 12, 2006, the content of which is incorporated herein by reference.

### FIELD OF THE INVENTION

This invention relates to compositions and methods for improving the performance of organophilic clay complexes within organic liquids that are used to form gels and other compositions. Depending on the constituents, the compositions may be useful as lubricating greases, oil-based muds, oil base packer fluids, paint-varnish-lacquer removers, paints, foundry molding sand binders, adhesives and sealants, inks, polyester laminating resins, polyester gel coats, cosmetics, detergents, and the like.

### BACKGROUND OF THE INVENTION

### Organoclays

It is well known that organic compounds that contain a cation will react under favorable conditions by ion-exchange with clays that contain a negative layer-lattice and exchangeable cations to form organophilic organic-clay products (referred to herein as “organoclays” and “organophilic clays” (OC)). If the organic cation contains at least one alkyl group containing at least 10 carbon atoms, then such organoclays will generally have the property of swelling in certain organic liquids. See for Example U.S. Pat. No. 2,531,427 and U.S. Pat. No. 2,966,506, both incorporated herein by reference, and the book “Clay Mineralogy”, 2nd Edition, 1968 by Ralph E. Grim (McGraw-Hill Book Company, Inc.), particularly Chapter 10, Clay-Mineral-Organic Reactions; pp. 356-368-Ionic Reactions, Smectite; and pp. 392-401-Organophilic Clay-Mineral Complexes (also incorporated herein by reference).

Since the commercial introduction of organoclays in the early 1950's, it has become well known that maximum gelling (thickening) efficiency of organoclays is achieved by adding a low molecular weight polar organic material to the composition. Such polar organic materials have been variously called dispersants, dispersion aids, solvating agents, dispersion agents and the like. See for example the following U.S. patents: O'Halloran U.S. Pat. No. 2,677,661; McCarthy et al. U.S. Pat. No. 2,704,276; Stratton U.S. Pat. No. 2,833,720; Stratton U.S. Pat. No. 2,879,229; Stansfield et al. U.S. Pat. No. 3,294,683. The use of such dispersion aids was found unnecessary when using specially designed organophilic clays derived from substituted quaternary ammonium compounds. See U.S. patents: Finlayson et al. U.S. Pat. No. 4,105,578 and Finlayson U.S. Pat. No. 4,208,218. Other patents refer to the use of specific organic compounds for enhancing the dispersion of organophilic clays; U.S. Pat. No. 4,434,075.

In this description, the term organophilic clay (OC), as known to those skilled in the art, generally refers to a class of chemically modified clays having varying degrees of hydrophobicity as is known to those skilled in the art. The clays may be derived from bentonite, hectorite, attapulgite and sepiolite and may be prepared by known processes. More specifically, OCs generally refer to clays that have been treated to allow them to disperse and produce viscosity within various liquid hydrocarbons including but not limited to synthetic oils, olefins, distillates, vegetable and animal oils, esters and ethers of vegetable and animal oils and silica oils.

In more specific forms, preferred OCs are structures having quaternary fatty-acid amines bonded to a bentonite, an absorbent aluminum phyllosilicate volcanic ash consisting mostly of montmorillonite, (Na,Ca)_{0.33}(Al,Mg)₂Si₄O₁₀(OH)₂.(H₂O)ₙ. In its native state bentonite is a hydrophilic molecule that can absorb up to seven times its weight in water.

In forming an OC, the chemical modification of clays with compounds such as quaternary amines may be conducted through dry or wet processes. Dry processes generally involve spraying quarternary amines to dry clay during grinding. In wet processes, pre-treated clays or native clay powders are dispersed in water solutions containing the quarternary amines. Generally, wet process clays are more expensive as additional manufacturing steps including, filtering, drying and other manufacturing steps are required. For example, in a wet process, pre-treatment of clay with a sodium hydroxide solution will ensure a higher degree of ion-exchange during later steps. Wet processes are generally thought to produce superior OCs as the degree of quarternary amine saturation on the clay particles is higher.

During OC synthesis, the nitrogen end of the quaternary amine, the hydrophilic end, is positively charged, and ion exchanges onto the clay platelet for sodium or calcium. The amines used are usually long chain type with 10-18 carbon atoms. After approximately 30 percent of the clay surface is coated with these amines it becomes hydrophobic and, with certain amines, organophilic.

After treatment, the organophilic clay will only absorb about 5 to 10% of its weight in water but approximately 40-70% of its weight of various oils and greases.

The effectiveness of the quarternary amines in enabling the OC to perform as a surfactant will depend on the R groups of the quarternary amines. Hydrophobic R groups having 10-18 carbon atoms create a hydrophobic tail that enables effective use of OCs as surfactants.

Other hydrophilic molecules may also be bonded to clay particles to create OCs as understood by those skilled in the art.

As the organoclay is introduced into water, positively charged sodium ions that were replaced by the nitrogen of the quarternary amine bond with dissolved chlorine ions, resulting in sodium salt that is washed away. The result is a neutral organoclay surfactant with a solid base.

In an oil/water system, the hydrophobic end of the amine dissolves into an organic phase (ie oil droplets) thus interfacing the OC with that oil droplet. As the interaction with the oil drop takes place “outside” of the clay particle (in contrast to adsorption of oil by carbon, which takes place inside clay pores of an untreated clay), the organoclay does not foul quickly. The hydrophilic edges of the clay interface with the water phase, with the resulting effect that the OC acts as a gelling agent.

In addition, organophilic clay can function as a prepolisher to activated carbon, ion exchange resins, and membranes (to prevent fouling), and as a post polisher to oil/water separators, dissolved air flotation (DAF) units, evaporators, membranes, and skimmers. Organophilic clay powder can be a component or the main staple of a flocculent clay powder. OCs are excellent adsorbers for the removal of oil, surfactants, and solvents, including methyl ethyl ketone, t-butyl alcohol (TBA), and other chemicals.

### Oil Muds

In the particular case of oil muds or oil-based drilling fluids, organophilic clays have been used in the past 50 years as a component of the drilling fluid to assist in creating drilling fluids having properties that enhance the drilling process. In particular, oil-based drilling fluids are used for cooling and lubrication, removal of cuttings and maintaining the well under pressure to control ingress of liquid and gas. A typical oil-based drilling mud includes an oil component (the continuous phase), a water component (the dispersed phase) and an organophilic clay which are mixed together to form a gel (also referred to as a drilling mud or oil mud). Emulsifiers, weight agents, fluid loss additives, salts and numerous other additives may be contained or dispersed into the mud. The ability of the drilling mud to maintain viscosity and emulsion stability generally determines the quality of the drilling mud.

The problems with conventional oil muds incorporating OCs are losses to viscosity and emulsion stability as well drilling progresses. Generally, as drilling muds are utilized downhole, emulsion stability will drop requiring the drill operators to introduce additional emulsifiers into the system to maintain the emulsion stability. The ongoing addition of emulsifiers to the oil mud increases the cost of drilling fluid during a drilling program. Compounding this problem is that the addition of further emulsifying agents to the oil mud has the effect of impairing the ability of OC to maintain viscosity within the drilling fluid which in turn requires the addition of further OCs which a) then further adds to the cost of the drilling fluid and b) then requires the addition of further emulsifiers.

As a result, there continues to be a need for oil-based drilling solutions that have superior viscosity and emulsion stability properties such that the viscosity and emulsion stability of the drillings solutions is both high and stable throughout the drilling program.

### Drilling Fluid Emulsifiers

The current state-of-the-art in drilling fluid emulsifiers are crude tall oil fatty acids (CTOFAs). Crude tall oil is a product of the paper and pulping industry and is a major byproduct of the kraft or sulfate processing of pinewood. Crude tall oil starts as tall oil soap which is separated from recovered black liquor in the kraft pulping process. The tall oil soap is acidified to yield crude tall oil. The resulting tall oil is then fractionated to produce fatty acids, rosin, and pitch. The typical chemical composition of CTO is shown in Table 1.

TABLE 1
Typical Composition of Tall Oil used as Primary
Emulsifier

| Fatty acids | | |
|---|---|---|
| Palmitic acid | CH₃(CH₂)₁₄COOH | 2% |
| Linoleic acid | CH₃—(CH₂)₄—(CH═CH—CH₂)₂—(CH₂)₆—COOH | 11% |
| Linoleic acid, conjugated (2) | CH₃(CH₂)₃CH═CHCH═CH—(CH₂)₆COOH | 5% |
| Oleic acid | CH₃(CH₂)₈CH═CH(CH₂)₇COOH | 16% |
| Palmitoleic acid (1) | CH₃(CH₂)₆CH═CH(CH₂)₇COOH | 1% |
| Stearic acid | CH₃(CH₂)₁₆COOH | 1% |
| Other fatty acids (3) | | 4% |
| Total Faffy acids | | 40% |
| Resin acids | | |
| Abietic acid | (CH₃)₄C₁₅H₁₇COOH | 11% |
| Dehydroabietic acid | (CH₃)₄C₁₅H₁₇COOH | 6% |
| Isopimaric acid | (CH₃)₃(CH₂)C₁₅H₂₃COOH | 4% |
| Levopimaric acid | (CH₃)₃(CH₂)C₁₅H₂₃COOH | ~2% |
| Neoabietic acid | (CH₃)₄C₁₅H₁₇COOH | ~2% |
| Palustric acid | (CH₃)₄C₁₅H₁₇COOH | ~2% |
| Pimaric acid | (CH₃)₃(CH₂)C₁₅H₂₃COOH | ~2% |
| Total Resin acids | | 29% |
| Unsaponifiable Matter | | |
| Avenasterol | | 0.0% |
| Brassicasterol | C₂₈H₄₆O | 0.0% |
| Campestanol | | 0.2% |
| Campesterol | C₂₈H₄₈O | 1.72% |
| Cholesterol | C₂₇H₄₆O | 0.0% |
| Desmosterol | C₂₇H₄₄O | 0.0% |
| Ergosterol | C₂₈H₄₄O | Trace |
| Fucosterol | C₂₉H₄₈O | 0.0% |
| Lanosterol | C₃₀H₅₀O | 0.0% |
| β-Sitostanol | C₂₉H₅₀O | 3.3% |
| β-Sitosterol | C₂₉H₅₀O | 25.3% |
| Stigmasterol | C₂₉H₅₂O | 0.3% |
| Total Unsaponifiables | | 31% |

The main advantage of CTOFAs is that they are relatively inexpensive as an emulsifier. However, the use of CTOFAs as emulsifiers within oil muds does not produce high and stable viscosity and emulsion stability and does not allow or enable the control of viscosity while optimizing the performance of the organophilic clay.

As a result, there continues to be a need for a class of emulsifying agents that effectively increase or decrease the viscosity and stability of organoclay/water/oil emulsions to provide a greater degree of control over the fluid properties of such emulsions. More specifically, there has been a need for methods and compositions that reduce the costs associated with traditional oil-based drilling fluids whilst providing control over the properties of the composition.

### SUMMARY OF THE INVENTION

In accordance with the invention, methods of preparing hydrocarbon, water and organophilic clay emulsions and compositions thereof are described.

In a first embodiment, the invention provides a method for controlling the viscosity of an oil and water emulsion comprising the step of introducing an effective amount of an emulsifier to an oil and water emulsion containing organophilic clay (OC) to produce a desired viscosity in the emulsion. An effective amount of an emulsifier, selected from the emulsifiers listed below, are those that generally can be used to increase the viscosity of an emulsion.

In this first embodiment, the emulsifier may be selected from any one of:
a. any one of a C8-C18 saturated fatty acid (SFA);
b. a blend of two or more different C8-C18 SFAs;
c. a blend of a C8-C18 SFA and at least one 2-5n (n is the number of double bonds) unsaturated fatty acid (UFA);
d. a vegetable oil selected from any one of safflower oil, olive oil, cottonseed oil, coconut oil, peanut oil, palm oil, and canola oil; and
e. tallow oil.

It is preferred that the amount of emulsifier and organophilic clay are selected to maximize the performance of the organophilic clay for the desired viscosity.

In one embodiment, it is also preferred that the amounts of organophilic clay and emulsifier are balanced to minimize the amount of organophilic clay for a desired viscosity and the amount of emulsifier is sequentially increased to produce the desired viscosity.

Further, various emulsifiers may be added to reduce the viscosity of the emulsion. Such viscosity lowering emulsifiers are blended with the emulsion and may be selected from any of any one of or a combination of an unsaturated fatty acid, resin acid, lanolin, tocopherols, beeswax, flax oil, or fish oil. A highly effective viscosity lowering emulsifier is abietic acid.

In another embodiment, the invention provides a method for controlling the viscosity of an oil and water emulsion comprising the step of introducing an effective amount of an emulsifier to an oil and water emulsion containing organophilic clay (OC) to produce a desired viscosity in the emulsion wherein the emulsifier is a blend of a C8-C18 saturated fatty acid (SFA) and at least one unsaturated fatty acid (UFA) and the ratio of SFA to UFA is adjusted to produce the desired viscosity.

In another embodiment, the invention provides a method for producing a hydrocarbon/water/organophilic clay emulsion having a desired viscosity comprising the steps of: a) blending a hydrocarbon continuous phase and a water dispersed phase together with an organophilic clay; and, b) introducing an effective amount of an emulsifier. The emulsifier selected may be from any emulsifier as described above and may include both viscosity increasing emulsifiers and viscosity reducing emulsifiers. The desired viscosity may be obtained by minimizing the amount of organophilic clay and increasing the amount of emulsifier to produce the desired viscosity thereby maximizing the performance of the organophilic clay.

In another embodiment, the invention provides a method of controlling the emulsion stability of an oil and water emulsion comprising the steps of introducing an effective amount of an emulsifier to an oil and water emulsion containing organophilic clay (OC) to produce a desired emulsion stability in the emulsion wherein the emulsifier is a C8-C18 saturated fatty acid (SFA) and at least one unsaturated fatty acid (UFA) and the ratio of SFA to UFA is adjusted to produce the desired emulsion stability.

In another embodiment, the invention provides a method of increasing the emulsion stability of an oil and water emulsion comprising the step of introducing an effective amount of a C8-C18 saturated fatty acid (SFA) emulsifier to an oil and water emulsion containing organophilic clay (OC).

In yet another embodiment, the invention provides a method of increasing the oil-wetting properties of an oil and water emulsion comprising the step of introducing an effective amount of at least one unsaturated fatty acid (UFA) emulsifier to an oil and water emulsion containing organophilic clay (OC).

In another aspect of the invention, various hydrocarbon/water/organophilic clay compositions having a desired viscosity are described. The emulsions comprise a hydrocarbon continuous phase; a water dispersed phase; an organophilic clay; and, an emulsifier. The emulsifier may be selected from:
i. any one of a C8-C18 saturated fatty acid (SFA);
ii. a blend of two or more different C8-C18 SFAs;
iii. a blend of a C8-C18 SFA and at least one 2-5n unsaturated fatty acid (UFA);
iv. a vegetable oil selected from any one of safflower oil, olive oil, cottonseed oil, coconut oil, peanut oil, palm oil, and canola oil; and
v. tallow oil

In preferred embodiments, the amounts of organophilic clay and emulsifier are selected to maximize the performance of the organophilic clay for the desired viscosity of the composition.

In various embodiments, the organophilic clay may be selected from any one of or a combination of a wet-process or dry-process clay.

The compositions will preferably have an emulsion stability greater than 500 volts.

In another aspect of the invention, a drilling fluid composition is described comprising: a hydrocarbon continuous phase; a water dispersed phase; an organophilic clay; and, an emulsifier, the emulsifier selected from those emulsifiers described above.

In various compositions, the hydrocarbon:water ratio is 1:1 to 99:1 (v/v).

It is preferred that the emulsifier for the drilling fluid composition is selected to maximize organophilic clay performance to produce a desired viscosity.

In yet another embodiment, the invention describes a method for drilling a wellbore comprising the steps of: a) operating a drilling assembly to drill a wellbore; and b) circulating an oil-based drilling fluid through the wellbore, the oil-based drilling fluid comprising: i) a hydrocarbon continuous phase; ii) a water dispersed phase; iii) an organophilic clay; and, iv) an emulsifier. In other embodiments, the viscosity of the drilling fluid may be adjusted by adding additional emulsifier to increase the viscosity of the drilling fluid or adding an effective amount of any one of or a combination of an unsaturated fatty acid, resin acid, lanolin, tocopherols, beeswax, flax oil, or fish oil to reduce the viscosity of the emulsion.

### BRIEF DESCRIPTION OF THE DRAWINGS

The invention is described with reference to the drawings wherein:

FIG. 1 is a graph showing the viscosity effect of CTOFAs at varying concentrations and shear rates;

FIG. 2 is a graph showing the viscosity effect of C18:1n-9cis at varying concentrations and shear rates;

FIG. 3 is a graph showing the viscosity effect of C18:2n-6cis at varying concentrations and shear rates;

FIG. 4 is a graph showing the viscosity effect of abietic acid at varying concentrations and shear rates;

FIG. 5 is a graph showing the viscosity effect of C18:3n-3cis at varying concentrations and shear rates;

FIG. 6 is a graph showing the viscosity effect of C22:1n-9cis at varying concentrations and shear rates;

FIG. 7 is a graph showing the viscosity effect of C4-C22 saturated fatty acids a varying shear rates;

FIG. 8 is a graph showing the viscosity effect of C10-C18 saturated fatty acids in a higher density continuous phase at varying shear rates;

FIG. 9 is a graph showing the viscosity effect of C10-C18 saturated fatty acids in a lower density continuous phase at varying shear rates;

FIG. 10 is a graph showing the viscosity effect of C4-C22 saturated fatty acids with a higher quality organophilic clay at varying shear rates;

FIG. 11 is a graph showing the viscosity effect of C4-C22 saturated fatty acids with a lower quality organophilic clay at varying shear rates;

FIG. 12 is a graph showing the viscosity effect of C8-C22 saturated fatty acids with a lower quality organophilic clay at varying shear rates;

FIG. 13 is a graph showing the viscosity effect of C8-C22 saturated fatty acids with a higher quality organophilic clay at varying shear rates;

FIG. 14 is a graph showing the viscosity effect of C8 saturated fatty acid at varying concentrations and shear rates;

FIG. 15 is a graph showing the viscosity effect of C12 saturated fatty acid at varying concentrations and shear rates;

FIG. 16 is a graph showing the viscosity effect of C16 saturated fatty acid at varying concentrations and shear rates;

FIG. 17 is a graph showing the viscosity effect of C18 saturated fatty acid at varying concentrations and shear rates;

FIG. 18 is a graph showing the viscosity effect of C22 saturated fatty acid at varying concentrations and shear rates;

FIG. 19 is a graph showing the viscosity effect of C12 saturated fatty acid at varying concentrations of organophilic clay at varying shear rates;

FIG. 20 is a graph showing the viscosity effect of blends of C10 and C12 saturated fatty acids at varying concentrations and shear rates;

FIG. 21 is a graph showing the viscosity effect of blends of C8 and C12 saturated fatty acids at varying concentrations and shear rates;

FIG. 22 is a graph showing the viscosity effect of blends of C12 and C22 saturated fatty acids at varying concentrations and shear rates;

FIG. 23 is a graph showing the viscosity effect of C12 saturated fatty acid at varying concentrations of water as the dispersed phase and shear rates;

FIG. 24 is a graph showing the viscosity effect of a blend of C12 saturated fatty acid and abietic acid at varying concentrations and shear rates;

FIG. 25 is a graph showing the viscosity effect of a blend of C12 saturated fatty acid and α-pinene at varying concentrations and shear rates;

FIG. 26 is a graph showing the viscosity effect of a blend of C12 saturated fatty acid and β-sitosterol at varying concentrations and shear rates;

FIG. 27 is a graph showing the viscosity effect of a blend of C12 saturated fatty acid and α-tocopherol at varying concentrations and shear rates;

FIG. 28 is a graph showing the viscosity effect of a blend of C12 saturated fatty acid and a blend of alpha, beta, sigma and delta tocopherols at varying concentrations and shear rates;

FIG. 29 is a graph showing the viscosity effect of a blend of C12 saturated fatty acid and C18:3n-3cis at varying concentrations and shear rates;

FIG. 30 is a graph showing the viscosity effect of a blend of C12 saturated fatty acid and C20:5n-3cis at varying concentrations and shear rates;

FIG. 31 is a graph showing the viscosity effect of a blend of C12 saturated fatty acid and lanolin at varying concentrations and shear rates;

FIG. 32 is a graph showing the viscosity effect of a blend of C12 saturated fatty acid and beeswax at varying concentrations and shear rates;

FIG. 33 is a graph showing the viscosity effect of commercial blends of coconut oil at varying shear rates;

FIG. 34 is a graph showing the viscosity effect of lanolin at varying concentrations and shear rates;

FIG. 35 is a graph showing the viscosity effect of flax seed oil at varying concentrations and shear rates;

FIG. 36 is a graph showing the viscosity effect of canola seed oil at varying concentrations and shear rates;

FIG. 37 is a graph showing the viscosity effect of safflower seed oil at varying concentrations and shear rates;

FIG. 38 is a graph showing the viscosity effect of canola seed oil at varying concentrations with a lower quality organophilic clay and at varying shear rates;

FIG. 39 is a graph showing the viscosity effect of safflower seed oil at varying concentrations with a lower quality organophilic clay and at varying shear rates;

FIG. 40 is a graph showing the viscosity effect of canola seed oil at varying concentrations with a lower quality organophilic clay and at varying shear rates;

FIG. 41 is a graph showing the viscosity effect of a commercial coconut oil at varying concentrations and shear rates;

FIG. 42 is a graph showing the viscosity effect of a olive oil at varying concentrations and shear rates;

FIG. 43 is a graph showing the viscosity effect of myristic acid at varying concentrations and shear rates;

FIG. 44 is a graph showing the viscosity effect of peanut oil at varying concentrations and shear rates;

FIG. 45 is a graph showing the viscosity effect of cottonseed oil at varying concentrations and shear rates;

FIG. 46 is a graph showing the viscosity effect of a commercial blend of coconut oil at varying concentrations and shear rates;

FIG. 47 is a graph showing the viscosity effect of red palm oil at varying concentrations and shear rates;

FIG. 48 is a graph showing the viscosity effect of palm kernel oil at varying concentrations and shear rates;

FIG. 49 is a graph showing the viscosity effect of distilled tallow at varying concentrations and shear rates;

FIG. 50 is a graph showing the emulsion stability of C4-C22 emulsions;

FIG. 51 is a schematic representation of the molecular structure of an OC and a monounsaturated fatty acid;

FIG. 52 is a schematic representation of the molecular structure of an OC and a di-unsaturated fatty acid;

FIG. 53 is a schematic representation of the molecular structure of an OC and a tri-unsaturated fatty acid;

FIG. 54 is a schematic representation of the molecular structure of a tri-unsaturated fatty acid with a water droplet;

FIG. 55 is a schematic representation of the molecular structure of a di-unsaturated fatty acid with a water droplet;

FIG. 56 is a schematic representation of the molecular structure of a monounsaturated fatty acid with a water droplet;

FIG. 57 is a schematic representation of the molecular structure of a saturated fatty acid with a water droplet;

FIG. 58 is a graph depicting average cost per day against well depth in a first test well using a drilling solution prepared in accordance with the invention; and,

FIG. 59 is a graph depicting average cost per day against well depth in a second test well using a drilling solution prepared in accordance with the invention.

### DETAILED DESCRIPTION OF THE INVENTION

In accordance with the invention, improved hydrocarbon, water and organophilic clay compositions and methods of preparing the compositions are described. The compositions in accordance with the invention have improved viscosity properties that enable their use in a variety of applications.

More specifically, the invention provides an effective tool to enable the creation of hydrocarbon, water and organophilic clay compositions wherein the “performance” of the organophilic clay within the composition can be substantially improved such that compositions of a given viscosity can be prepared while minimizing the amount organophilic clay in the composition whilst also providing an effective tool for compositions to be created having desired viscosity characteristics. Other fluid properties may also be improved within the compositions.

As organophilic clay can be one of the most expensive components within specific hydrocarbon/water/organophilic clay compositions (particularly with respect to oil-based drilling fluids), the methods and compositions described can provide significant cost advantages over previous methods and compositions and allow a greater degree of flexibility in the creation of hydrocarbon/water/organophilic clay compositions having desired properties.

More specifically, the inventor has recognized that the use of saturated fatty acids, blends of saturated fatty acids, blends of saturated fatty acids and unsaturated fatty acids, certain vegetable oils, and tallow oil as an emulsifier within hydrocarbon/water/organophilic clay compositions effectively allows the viscosity of a hydrocarbon/water/organophilic clay composition to be “improved” as compared to similar hydrocarbon/water/organophilic clay compositions that use dissimilar emulsifiers. In addition, the inventor has recognized that other emulsifiers may be utilized to decrease the viscosity of such emulsions and that by adjusting the ratio between various emulsifiers various properties may be controlled within the emulsions.

In the context of this description, the compositions and methods described all relate oil-based drilling solutions that, as described below, include a hydrocarbon continuous phase, a water dispersed phase, an organophilic clay and an emulsifier. The amount of hydrocarbon phase and water phase in a given emulsion may be varied from as low as 50:50 (hydrocarbon:water (v/v)) to as high as 99:1. At the lower end of this range, emulsion stability is substantially lower and the ability to alter viscosity requires that large amounts of organophilic clay be added to the mixture. Similarly, at the upper end, the ability to control viscosity within the emulsion is more difficult. As a result, an approximate hydrocarbon:water ratio of 80:20 to 90:10 (v/v) is a practical ratio that is commonly used for drilling solutions.

In this description, a representative drilling solution having a hydrocarbon:water ratio of 90:10 (v/v) was used as a standard to demonstrate the effect of emulsifiers on the organophilic clay performance, viscosity and emulsion stability. In addition, a relatively narrow range of organophilic clay ratios relative to the total mass of solution was utilized. Each of these amounts was selected as a practical amount to demonstrate the effect of altering the amount of organophilic clay and/or emulsifier relative to the other components. While experiments were not performed across the full range of ratios where such compositions could be made, it would be understood by one skilled in the art that in the event that one parameter was changed that adjustment of another parameter to compensate for the change in other parameters would be made.

Thus, in the context of this description, it is understood that the change in one parameter may require that at least one other parameter be changed in order to optimize the performance of the composition. For example, if the stated objective in creating a composition for a given hydrocarbon:water ratio is to minimize the usage of organophilic clay in that composition, the worker skilled in the art would understand that adjustment of both the amount of organophilic clay and emulsifier in the composition may be required to obtain a composition realizing the stated objective and that such an optimization process, while not readily predictable, is understood by those skilled in the art.

### Experimental

Different organophilic clays (OCs) were mixed with various hydrocarbons and emulsifiers to determine the effect of the OCs, hydrocarbons and emulsifiers on viscosity and emulsion stability. The experiments examined the effect of organophilic clay composition (quality) and emulsifier structure including the effects of chain length, degree of saturation, position of double bonds and wt % relative to organophilic clay within different continuous phases.

The following organophilic clays were investigated as shown in Table 2.

TABLE 2
Organophilic Clays

| Clay | Manufacturing Process | Quality/Relative Cost |
|---|---|---|
| IMG-400 ™ | Wet | Medium |
| Bentone 150 ™ | Wet | High |
| Bentone 920 ™ | Dry | Low |
| Claytone 3 ™ | Wet | Medium |
| Claytone EM ™ | Wet | High |

In the context of this description, the terms low, medium and high refer to the general classification of an OC in terms of its relative cost and degree of processing.

### Hydrocarbons

Representative hydrocarbons tested as the continuous phase are shown in Table 3.

TABLE 3
Hydrocarbons as Continuous Phase

| Hydrocarbon | Relative Density |
|---|---|
| HT 40 N ™ | mid-range fraction |
| Distillate 822 ™ | heavier diesel fraction |
| | acidic |
| Amodril 775 ™ | light fraction |

Other hydrocarbons including synthetic oils, vegetable oils and esters and ethers of vegetable oils may also be utilized as the continuous phase.

### Base Solution

A base drilling fluid solution was created for testing whereby individual constituents of the formulation could be altered to examine the effect on drilling fluid properties. The base drilling fluid solution was a miscible mix of a hydrocarbon, water, organophilic clay and emulsifier. The general formulation of the base drilling solution is shown in Table 4.

TABLE 4
Base Drilling Solution

| Component | Volume % | Weight % |
|---|---|---|
| Oil | 90 | |
| Water | 10 | |
| Calcium Chloride (CaCl₂) | | 25 wt % of water |
| Organophilic Clay | | 5.7 wt % of water* |
| Quick Lime (CaO) | | 28.5 wt % of water* |
| Emulsifier | | 0.95 wt % of water* |

*unless otherwise noted

### Preparation

The oil, water, calcium chloride and organophilic clay were mixed at high speed to create a highly dispersed slurry. Mixing was continued until the slurry temperature reached 70° C. Emulsifiers were added to individual samples of each solution and again mixed at high speed for 3 minutes. CaO was then added and blended for 2 minutes at high speed. The calcium chloride was added in accordance with standard drilling fluid preparation procedures as an additive to provide secondary fluid stabilization as is known to those skilled in the art.

Prior to testing, the samples were subsequently heat aged in hot rolling cells for 18-24 hours to simulate downhole conditions.

### Fluid Property Measurements

Viscosity measurements were made using a Fann Variable Speed concentric cylinder viscometer. Data points were collected at 600, 300, 200, 100, 6, 3, RPM points.

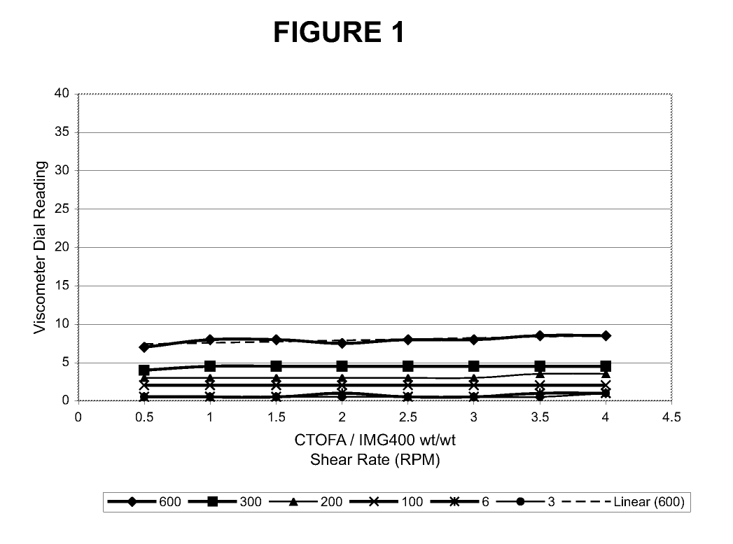

Within this description, viscosity effect is defined as a quantitative increase in viscosity of one solution with variable emulsifiers in comparison to the viscosity of a similar solution using CTOFAs as emulsifiers (FIG. 1). Relative shear stress (viscosity) is the dial reading on the Fann 35 variable speed viscometer used to measure fluid viscosity at the indicated rpm. Viscosity readings in the range of 0-20 at shear rates of 300-600 rpm are considered to exhibit no viscosity effect, viscosity readings in the range of 20-40 are considered to show a minor viscosity effect, viscosity readings in the range of 40-100 are considered to show significant viscosity effect and viscosity readings above 100 are considered to show a very significant viscosity effect.

Emulsion Stability was measured using an OFI Emulsion stability meter. Each measurement was performed by inserting the ES probe into the solution at 120° F. [48.9° C.]. The ES meter automatically applies an increasing voltage (from 0 to 1999 volts) across an electrode gap in the probe. Maximum voltage that the solution will sustain across the gap before conducting current is displayed as the ES voltage. Note that emulsion stabilities of 2000 volts are not in fact the actual ES as the meter had reached maximum capacity and several measured ES values were actually in excess of 2000.

### Emulsifier Investigations

The experiments summarized in FIGS. 1-6 were conducted to investigate the effect of the degree of unsaturation of the emulsifier in enhancing the viscosity of modified base solutions. In each case, a base solution was prepared using IMG 400 as an OC. As shown in FIG. 1, bulk crude tall oil fatty acids (CTOFAs) were used as an emulsifier to provide a base-line for viscosity investigations. CTOFAs represent the “state-of-the-art” as emulsifiers in drilling fluid compositions.

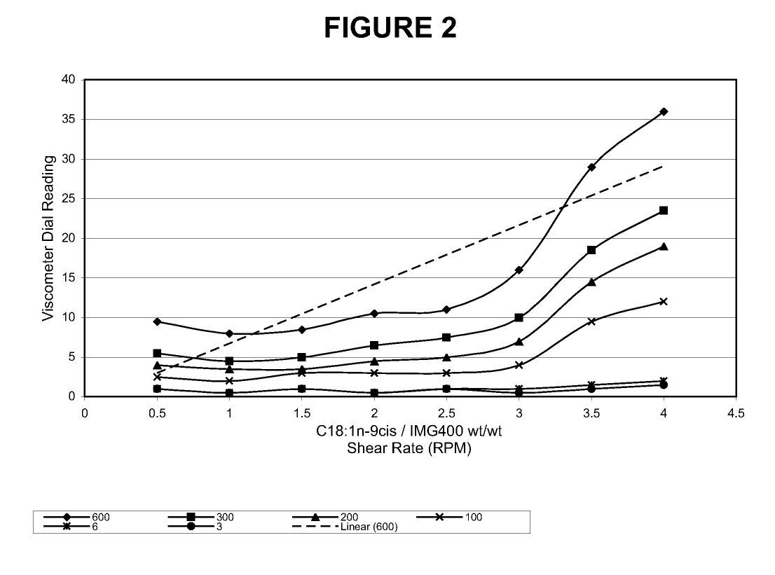

The results shown in FIGS. 1-6 and Table 5 show the effect of bulk CTOFAs as an emulsifier of the dispersed polar phase of an emulsion (FIG. 1) as well the effect of the primary fatty acids that make up CTOFAs (FIGS. 2-6).

Initial testing was performed on the saponifiable component parts of the crude tall oil (Table 1). As shown in Table 1, crude tall oil typically comprises 35-40% unsaturated fatty acids with the majority of the acids being; oleic C18:1n-9cis, linoleic C18:2n-6cis; 20-30% resin acids typically Abietic (diterpene) C₂₀H₃₀O₂; and, 30-40% phytosterols, typically β-Sitosterol.

In addition, a test of the effects of alpha-Linoleic acid C18:3n-3cis and C22:1 n-9cis was also done to determine the effect of increasing unsaturation on organophilic clay performance.

TABLE 5
Emulsifier Investigations
EMULSIFIER INVESTIGATIONS

| | | | Max | | |
|---|---|---|---|---|---|
| | Emulsifier | Double | Viscosity | | Reference |
| Emulsifier | Comments | Bonds | (nominal) | Observations | to FIG. |
| Crude Tall Oil Fatty | A mixture of various | multiple | 9 | no viscosity (V) effect | 1 |
| Acids (CTOFA) | fatty acids of varying | | | | |
| | chain lengths and | | | | |
| | saturation | | | | |
| C18:1n-9cis | 1 double bond | 1 | 35 | Minimal V effect | 2 |
| C18:2n-6cis | 2 double bonds | 2 | 20 | No V effect | 3 |
| Abietic Acid | 3 ring FA, very stiff | multiple | 10 | No V effect | 4 |
| C18:3n-6cis | 3 double bonds | 3 | 15 | No V effect | 5 |
| C22:1n-9cis | Longer chain | 1 | 10 | No V effect | 6 |

FIG. 1 shows that bulk CTOFAs have no effect on fluid viscosity at varying CTOFA levels. In addition, the emulsion stability of the CTOFA emulsions was less than 500 volts at varying CTOFA levels (Table 12).

FIG. 2 shows that oleic acid (C18:1n-9cis) as a primary emulsifier had a minor effect in boosting base composition viscosity at higher concentrations and shear rates.

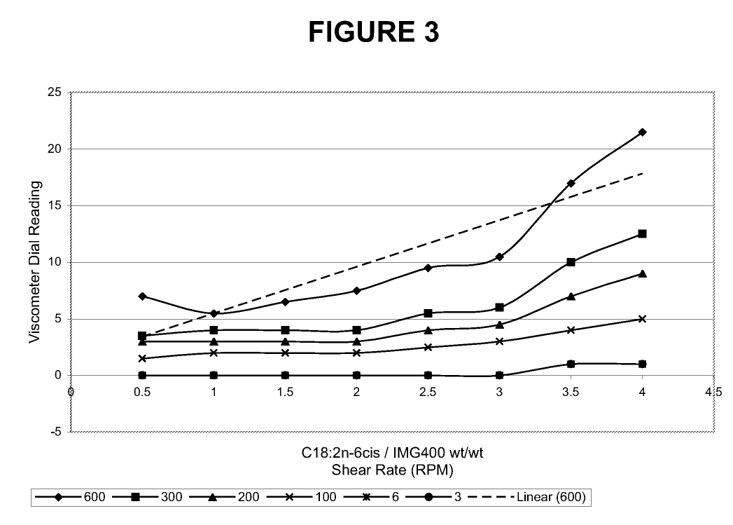

FIG. 3 shows that linoleic acid (C18:2n-6cis) as a primary emulsifier had no effect in boosting base composition viscosity.

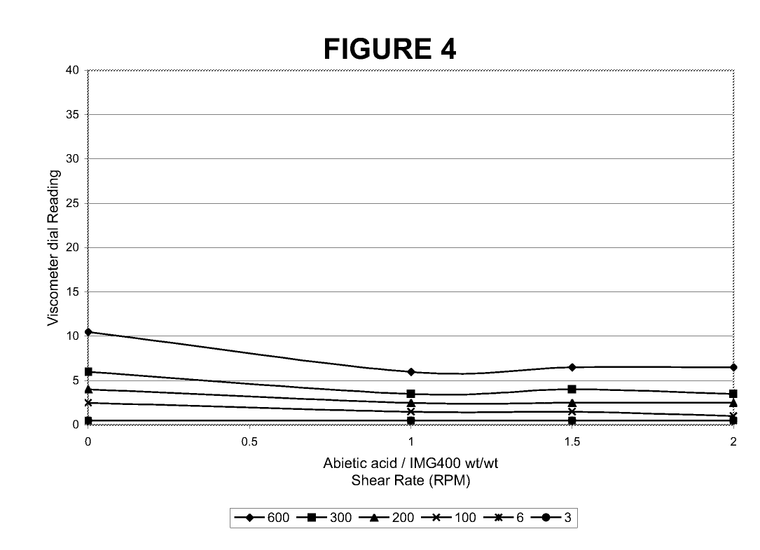

FIG. 4 shows that abietic acid as a primary emulsifier had no viscosity effect and in fact demonstrates a viscosity reducing effect at increased dosages.

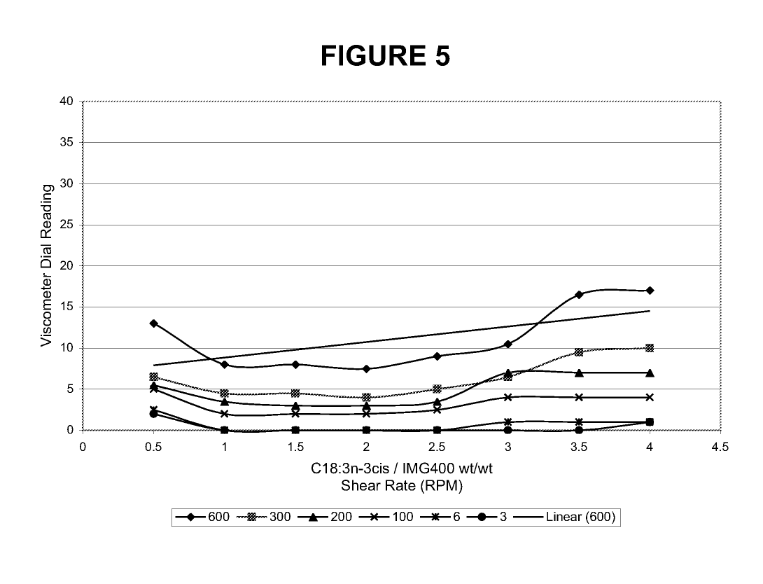

FIG. 5 shows that alpha-linoleic acid (C18:3n-3-cis) as a primary emulsifier produces no viscosity effect.

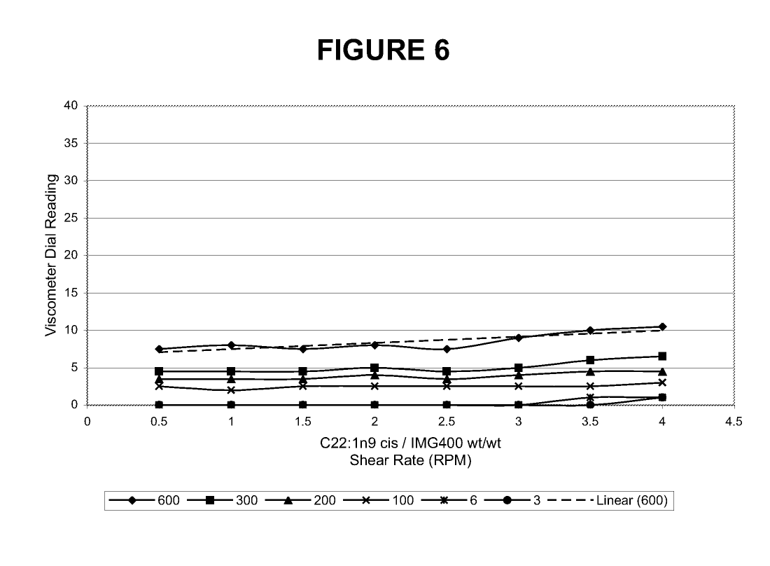

FIG. 6 shows that erucic (C22:1n:9-cis) fatty acid as a primary emulsifier produces no viscosity effect.

In summary, the results of FIGS. 1-6 indicate that neither a bulk crude tall oil nor the primary fatty acid components of the crude tall oil produce any viscosity effect. Importantly, the primary fatty acids of a crude tall oil all have at least one double bond in their respective hydrocarbon chains.

### Chain Length Investigations

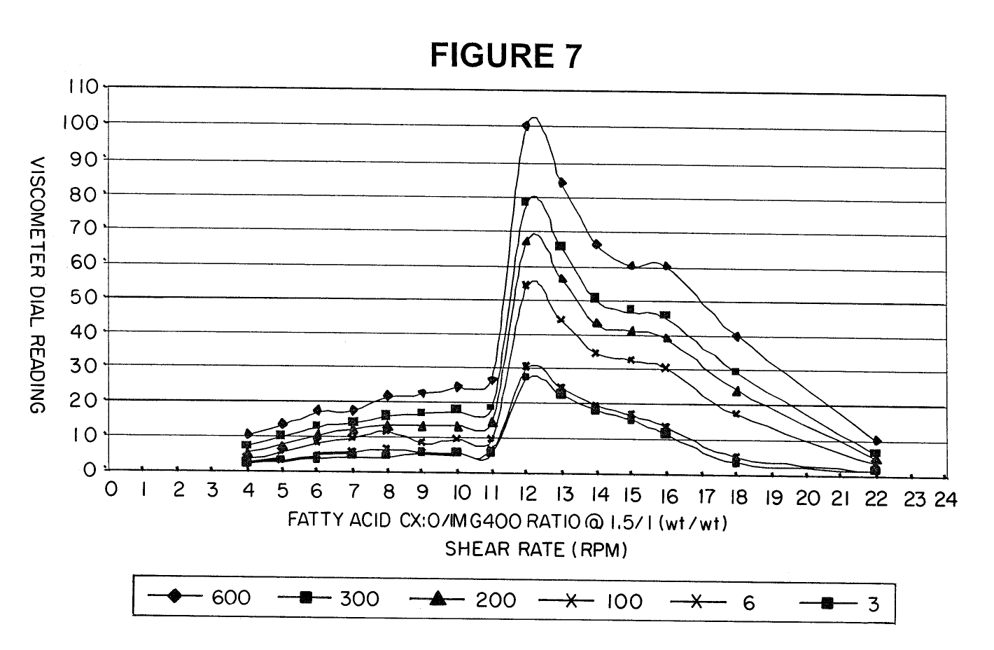

With reference to FIGS. 7-13 and Table 6, the effect of chain length in saturated fatty acids as primary emulsifier was investigated. Variations in OC, oil phase composition and the effect of certain additives were also investigated.

TABLE 6
Chain Length Investigations
CHAIN LENGTH INVESTIGATIONS

| | | | Max | | |
|---|---|---|---|---|---|
| | Composition | Double | viscosity | | |
| Emulsifier | Comments | Bonds | (nominal) | Comments | FIG. |
| C4:0 to C22:0 | Saturated FAs from | 0 | 100 | Significant V effect for | 7 |
| | C4 to C22 | | | C12-C18 FAs | |
| C10:0 to C18:0 | C10-C18 | 0 | 25 | Minor V effect. | 8 |
| | Heavier oil, Distillate | | | Heavier fraction | |
| | 822 | | | | |
| C10:0 to C18:0 | C10-C18 | 0 | 90 | Significant V effect. | 9 |
| | Lighter Oil, Amodril | | | Lighter Oil fraction | |
| C4:0 to C22:0 | C4-C22 | 0 | 80 | Significant V effect | 10 |
| | Bentone 150 | | | | |
| C4:0 to C22:0 | C4-C22 | 0 | 110 | Very significant V effect. | 11 |
| | Bentone 920 | | | | |
| C8:0 to C22:0 | C8-C22 | 0 | 80 | Significant V effect | 12 |
| | Claytone 3 | | | | |
| C8:0 to C22:0 | C8-C22 | 0 | 110 | Very significant V effect. | 13 |
| | Claytone EM | | | | |

FIG. 7 summarizes the viscosity effect for C4-C22 saturated fatty acids in compositions comprising a mid-fraction oil phase and a medium quality wet OC (IMG 400). The results show a significant viscosity effect for C12-C18 fatty acids at higher shear rates and a minor viscosity effect at lower shear rates for C12-C13 fatty acids.

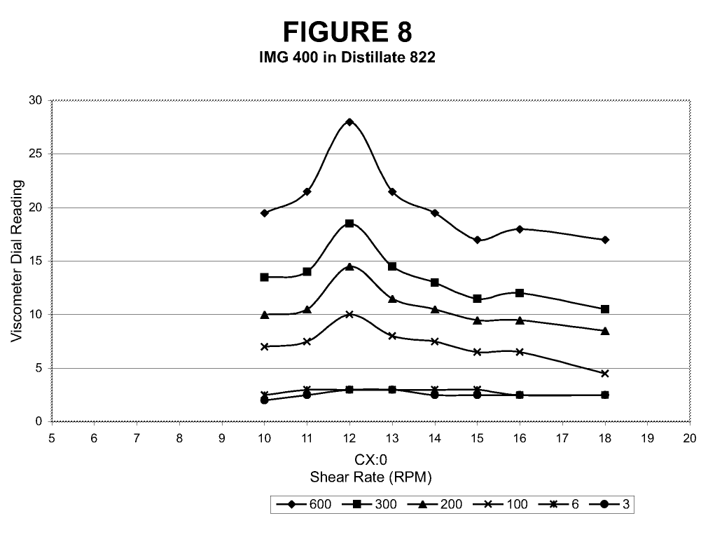

FIG. 8 summarizes the viscosity effect for C12-C18 saturated fatty acids in compositions comprising a heavier-fraction oil phase (Distillate 822). The results show a minor viscosity effect for C11-C13 fatty acids at higher shear rates.

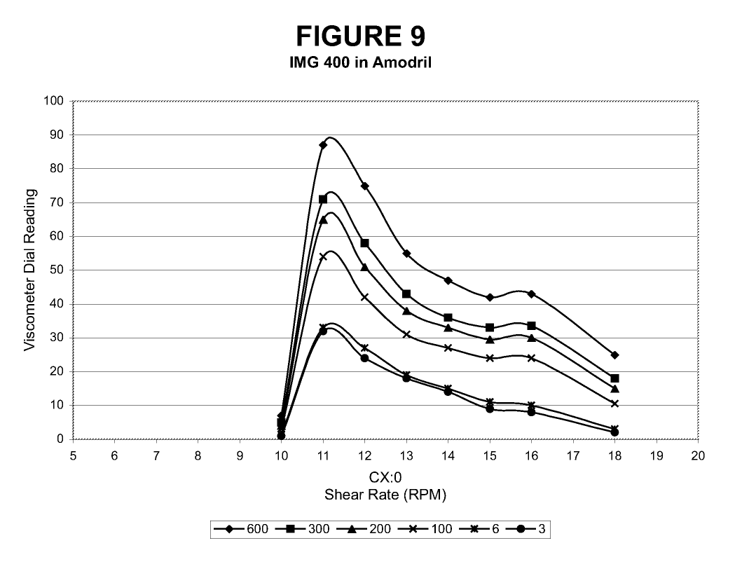

FIG. 9 summaries the viscosity effect for C10-C18 saturated fatty acids as a primary emulsifier in compositions comprising a lighter-fraction oil phase (Amodril). The results show a significant viscosity effect for C11-C16 fatty acids at higher shear rates and a minor viscosity effect for C11-C16 fatty acids at middle range shear rates. Peak viscosity effect is observed for C11 FAs.

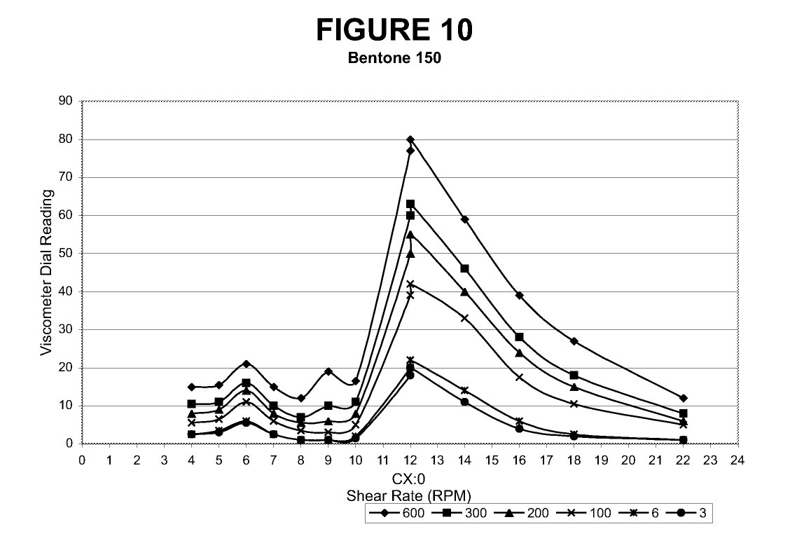

FIG. 10 summarizes the viscosity effect for C4-C22 saturated fatty acids as a primary emulsifier in compositions comprising a higher quality wet-blend OC (Bentone 150) and mid-density oil phase HT 40N. The results show a significant viscosity effect for C12-C16 fatty acids at higher shear rates and a minor viscosity effect for C12-C16 fatty acids at middle range shear rates. It is noted that the peak viscosity for the OC is less than that observed in FIG. 7 which utilized a lower quality OC. Peak viscosity effect is observed for C12 FAs.

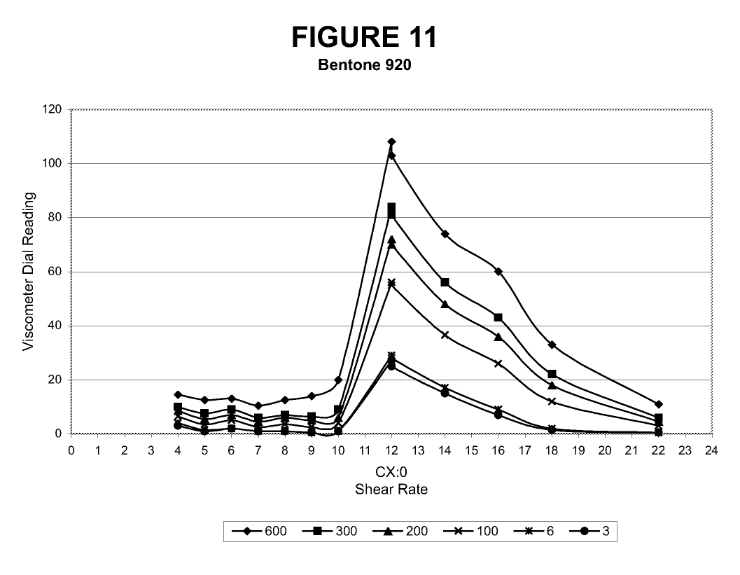

FIG. 11 summarizes the viscosity effect for C4-C22 saturated fatty acids as primary emulsifier in compositions comprising a less-expensive dry-blend OC (Bentone 920). The results show a very significant viscosity effect for C12 FAs at higher shear rates and a significant viscosity effect for C12-C18 at higher shear rates. Peak viscosity effect is observed for C12 FAs.

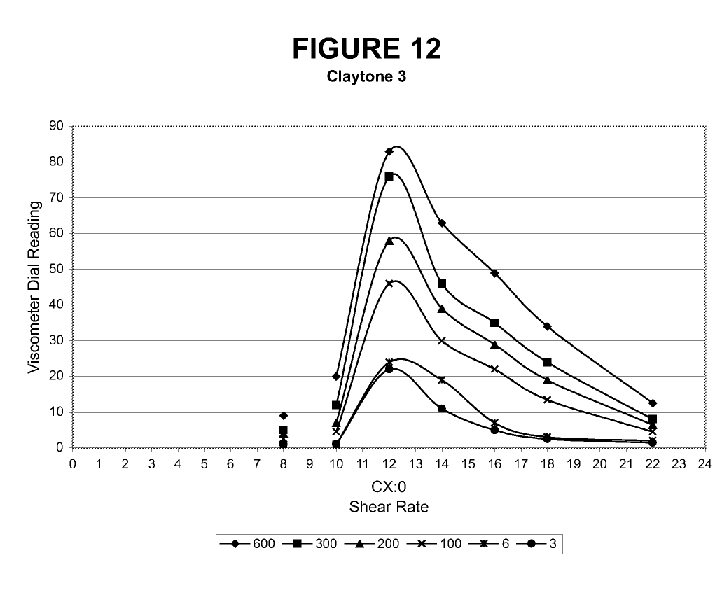

FIG. 12 summarizes the viscosity effect for C8-C22 saturated fatty acids as primary emulsifier in compositions comprising a less-expensive wet-blend OC (Claytone 3). The results show a significant viscosity effect for C12-C18 FAs at higher shear rates and a minor viscosity effect for C12-C18 FAs at middle range shear rates. Peak viscosity effect is observed for C12 FAs.

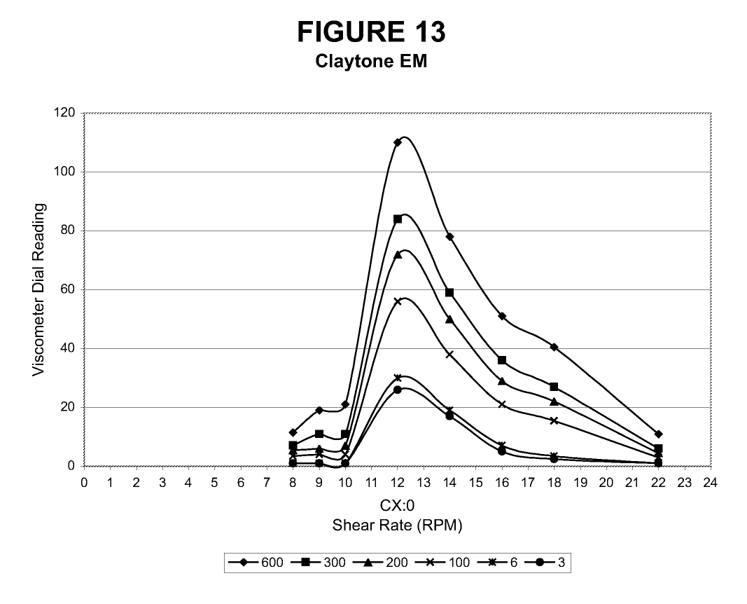

FIG. 13 summarizes the viscosity effect for C8-C22 saturated fatty acids as primary emulsifier in compositions comprising a more-expensive wet-blend OC (Claytone EM). The results show a very significant viscosity effect for C12 FAs at higher shear rates and a significant viscosity effect for C12-C18 FAs at higher shear rates. Peak viscosity effect is observed for C12 FAs.

In summary, FIGS. 7-13 indicate that the OC quality has little effect on the viscosity suggesting that the use of higher quality OCs is not required for viscosity effect. In addition, saturated acids in C11-C18 produced significant or very significant viscosity effects.

### Concentration/Dose Response Investigations

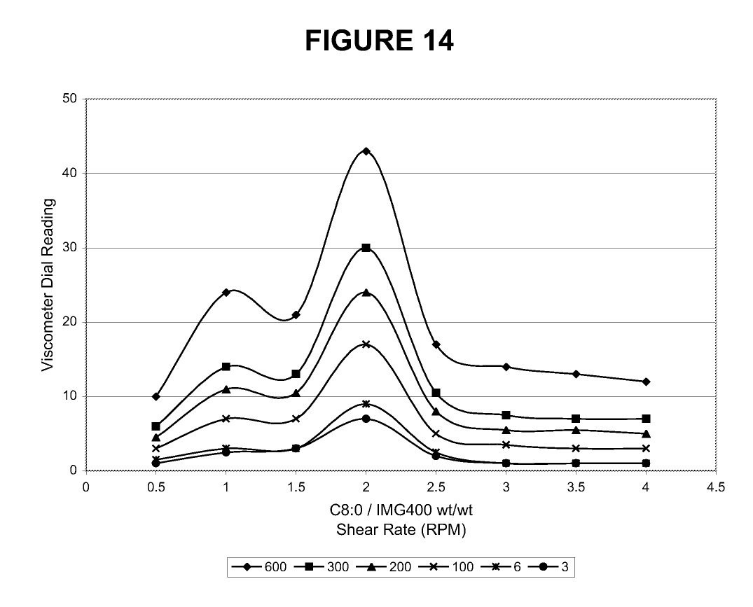

With reference to FIGS. 14-19 and Table 7, the effect of the concentration of primary emulsifier was investigated for saturated fatty acids of varying chain length.

TABLE 7
Dose Response Investigations
DOSE RESPONSE INVESTIGATIONS

| | | | Max | | |
|---|---|---|---|---|---|
| | Composition | Double | viscosity | | |
| Emulsifier | Comments | Bonds | (nominal) | Comments | FIG. |
| C8:0 | Saturated FA C8:0 | 0 | 45 | Base solution IMG 400 | 14 |
| | | | | Greatest effect at 2 wt % FA | |
| C12:0 | Saturated FA C12:0 | 0 | 250 | With increasing FA, the v | 15 |
| | | | | effect kept increasing, no | |
| | | | | plateau seen. | |
| C16:0 | Saturated FA C16:0 | 0 | 130 | With increasing FA, the v | 16 |
| | | | | effect kept increasing, no | |
| | | | | plateau seen. | |
| C18:0 | Saturated FA C18:0 | 0 | 105 | Plateau seen at 3.5 wt % | 17 |
| C22:0 | Saturated FA C22:0 | 0 | 50 | Minor v effect | 18 |
| C12:0 | Saturated FA C12:0 | 0 | 115 | Peak at 1.25 pounds of C12 | 19 |
| | | | | per barrel of clay. | |

FIG. 14 shows that saturated C8 FA as a primary emulsifier showed a minor viscosity effect at a FA:OC ratio (w/w) of 2.0 at higher shear rates.

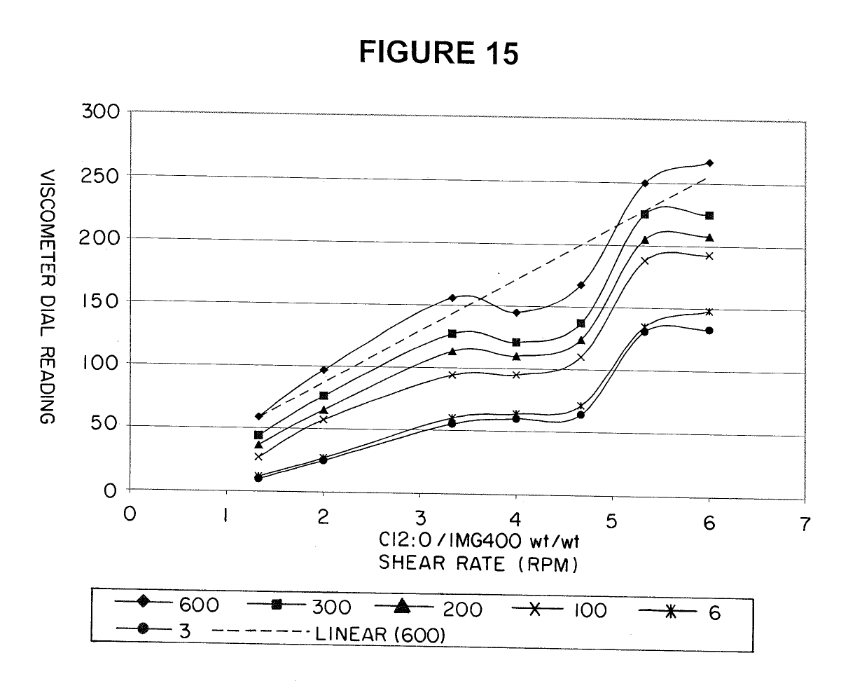

FIG. 15 shows that saturated C12 FA as a primary emulsifier showed a very significant viscosity effect at FA:OC ratios (w/w) greater than 2 at higher shear rates. Peak viscosity was observed at FA:OC ratio of 6. Significant viscosity effect was observed for FA:OC ratios of greater than 3.0 at all shear rates.

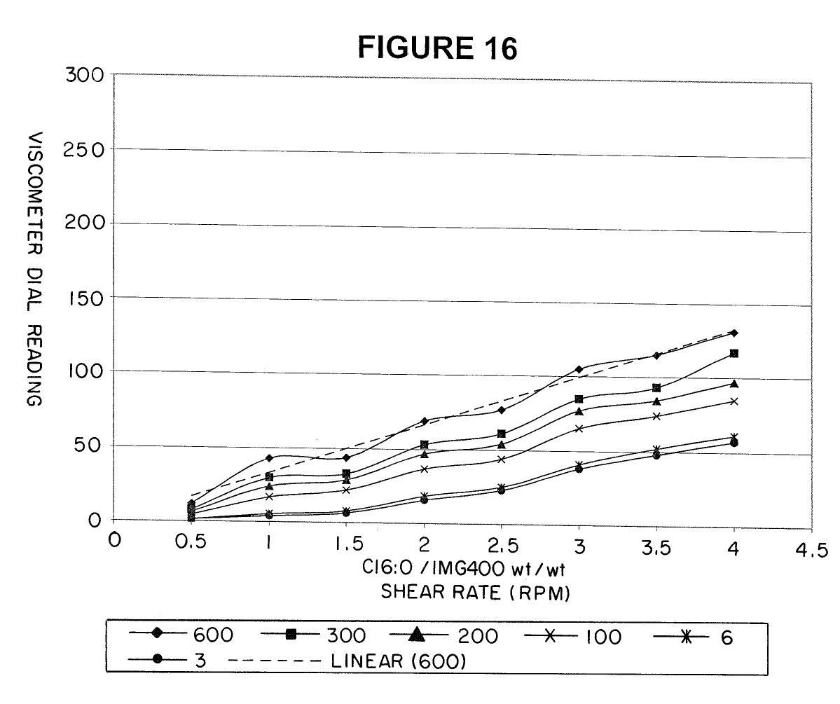

FIG. 16 shows that saturated C16 FA as a primary emulsifier showed a very significant viscosity effect at FA:OC ratios (w/w) greater than 3 at higher shear rates. No peak viscosity was observed within the tested range. Significant viscosity effect was observed for FA:OC ratios of greater than 1.0 at middle-range shear rates.

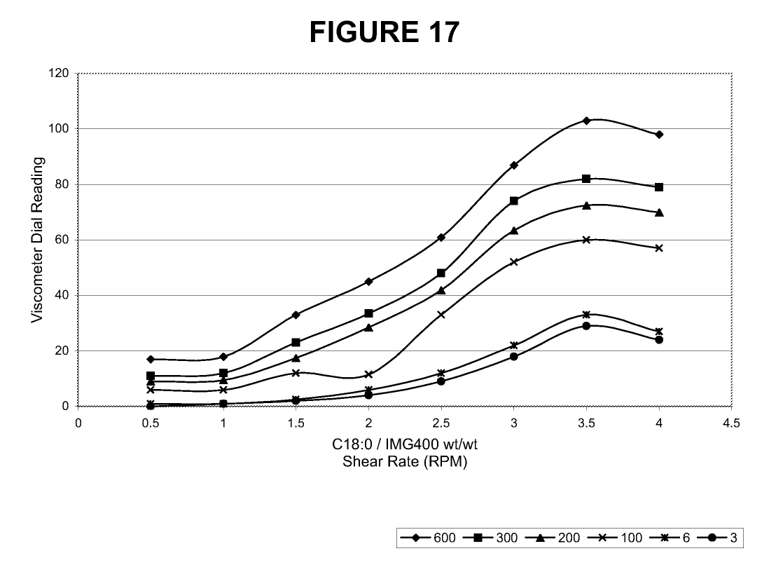

FIG. 17 shows that saturated C18 FA as a primary emulsifier showed a very significant viscosity effect at FA:OC ratios (w/w) of 3.5 at higher shear rates. Peak viscosity was observed at FA:OC ratio of 3.5. Significant viscosity effect was observed for FA:OC ratios of greater than 1.5 at middle-range shear rates.

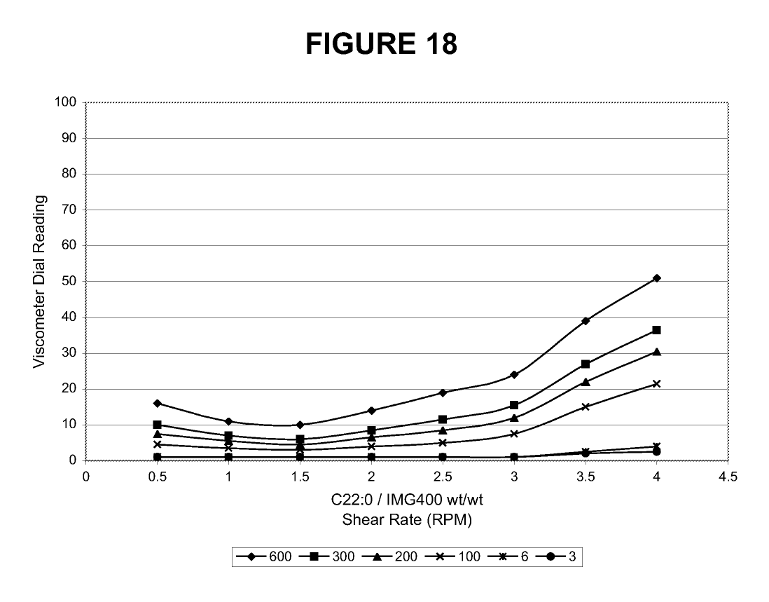

FIG. 18 shows that saturated C22 FA as a primary emulsifier showed a minor viscosity effect at FA:OC ratios (w/w) greater than 3 at higher shear rates.

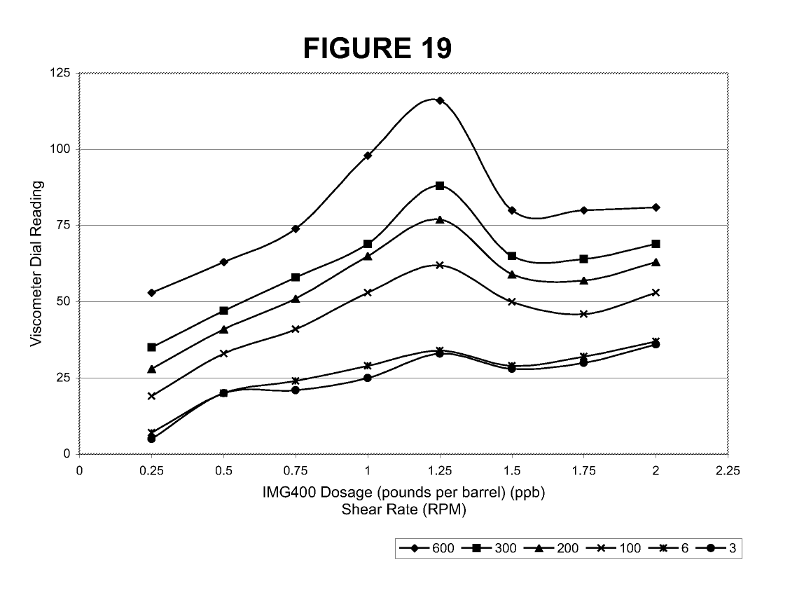

FIG. 19 shows that a very significant viscosity effect occurs at a dosage of 1.25 ppb OC at high shear rates and a significant viscosity effect occurs at greater than 0.5 ppb OC at middle-range shear rates.

In summary, FIGS. 14-19 show that FA:OC ratios may be varied for different FAs to produce the viscosity effect.

### Blend Investigations

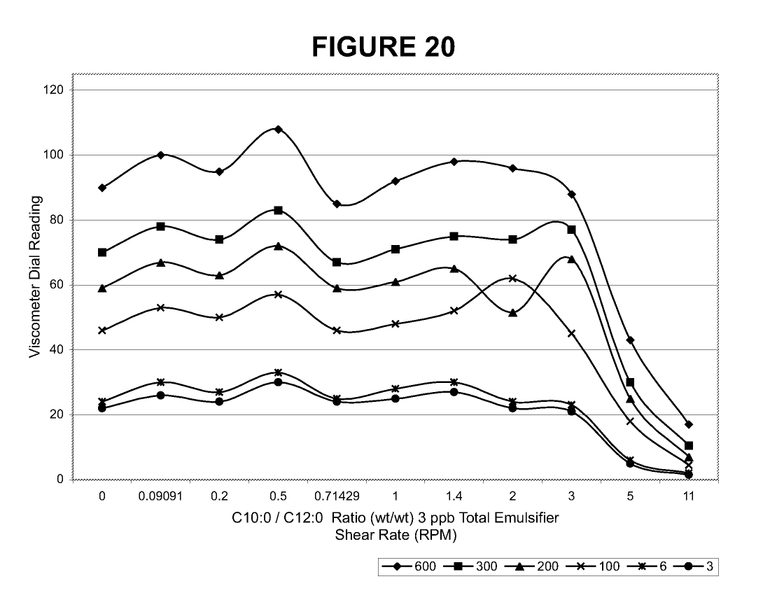

With reference to FIGS. 20-22 and Table 8, the effect of blending saturated fatty acids together was investigated.

TABLE 8
Blend Investigations
BLEND INVESTIGATIONS

| | | | Max | | |
|---|---|---|---|---|---|
| | Composition | Double | viscosity | | |
| Emulsifier | Comments | Bonds | (nominal) | Comments | FIG. |
| C10/C12 | Saturated FA C10 | 0 | 110 | An increasing quantity of | 20 |
| | and C12 | | | C10 relative to C12. As the | |
| | | | | ratio increases so that there | |
| | | | | is an increased amount of | |
| | | | | C10, the v effect will drop | |
| | | | | off. Shows synergies. | |
| C8/C12 | Saturated FA C8 and | 0 | 120 | An increasing quantity of | 21 |
| | C12 | | | C8 relative to C12. As the | |
| | | | | ratio increases so that there | |
| | | | | is an increased amount of | |
| | | | | C8, the v effect will drop | |
| | | | | off. Shows synergies. | |
| C12/C22 | Saturated FA C12 | 0 | 95 | As the ratio of C22 | 22 |
| | and C22 | | | increases, the v effect is | |
| | | | | reduced. | |

With reference to FIG. 20, the effect of increasing the amount of C12 saturated FA relative to C10 saturated FA is shown. This experiment showed that a range of C10:C12 ratios exhibit significant or very significant viscosity effect at high shear rates and that above a threshold value, interaction between the C10 and C12 FAs will destroy the viscosity effect.

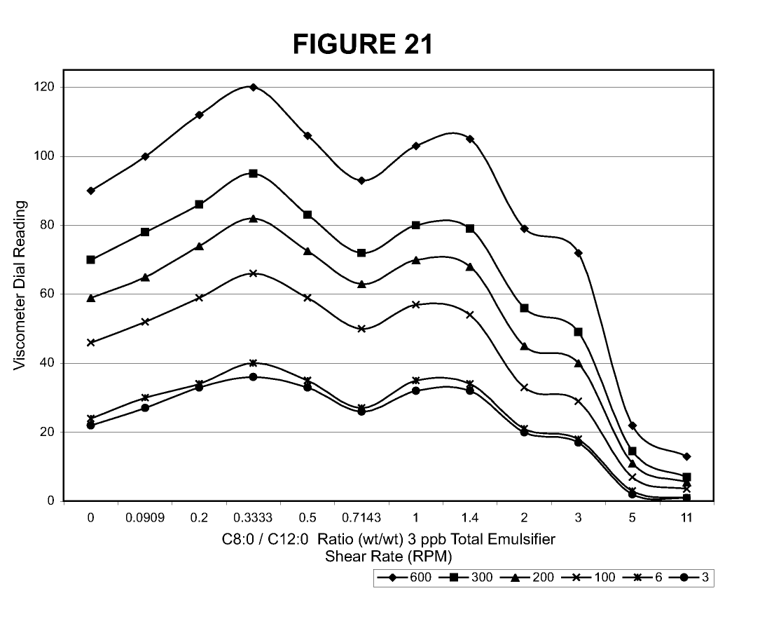

With reference to FIG. 21, the effect of increasing the amount of C12 saturated FA relative to C8 saturated FA is shown. This experiment showed that a range of C8:C12 ratios exhibit significant or very significant viscosity effect at high shear rates and that above a threshold value, interaction between the C8 and C12 FAs will destroy the viscosity effect. This experiment also shows that a certain blend ratios a boost in viscosity effect may occur.

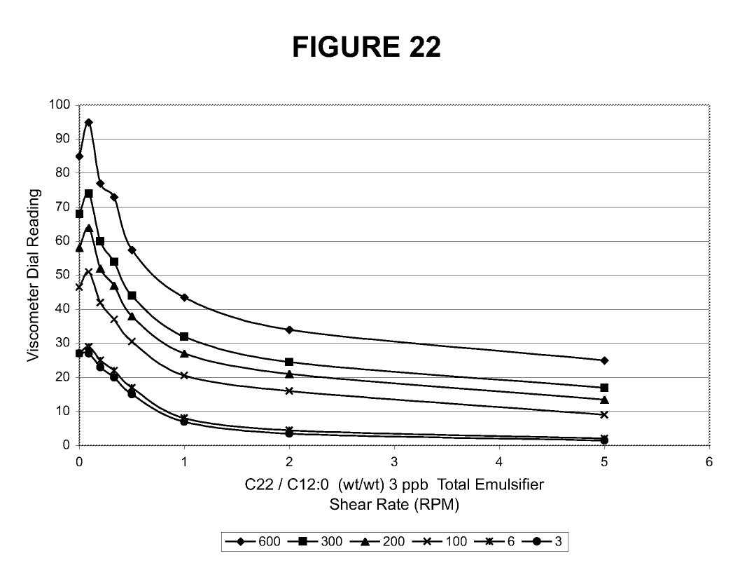

With reference to FIG. 22, the effect of increasing the amount of C22 saturated FA relative to C12 saturated FA is shown. This experiment showed that an increasing C22:C12 ratio negatively affected the viscosity effect at relatively low C22 concentrations.

In summary, FIGS. 20-22 show that synergistic effects occur between blends of FAs used as a primary emulsifier. Some interactions may be positive and others may be negative based on the relative concentrations.

### Water Effect Investigations

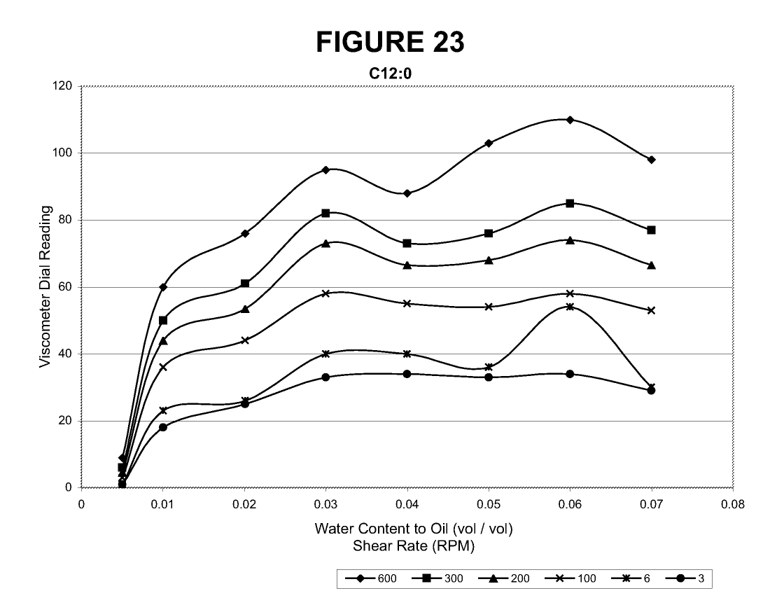

With reference to FIG. 23 and Table 9, the effect of increasing the amount of water relative to the oil phase (continuous phase) was investigated.

TABLE 9
Water Effect Investigations
WATER EFFECT INVESTIGATIONS

| | | | Max | | |
|---|---|---|---|---|---|
| | Composition | Double | viscosity | | |
| Emulsifier | Comments | Bonds | (nominal) | Comments | FIG. |
| C12 | Saturated FA C12 | 0 | 110 | As water content increased, | 23 |
| | | | | viscosity effect increased | |
| | | | | until a plateau was | |
| | | | | observed. | |

With reference to FIG. 23, the effect of increasing the volume % of the water phase relative to the hydrocarbon phase is shown for a C12 FA using IMG 400 OC. The results show that the relative proportion of the water phase may be increased to produce a significant or very significant viscosity effect until a plateau is observed.

C12 Blends with Other Fas

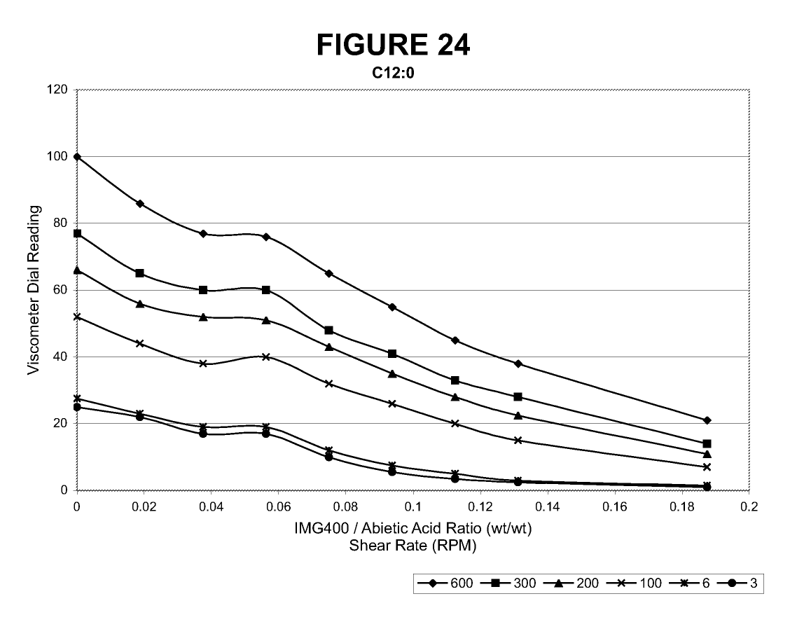

FIGS. 24-32 and Table 10 show the results of blending a saturated C12 FA with a variety of other FA molecules.

TABLE 10
C12/Other FA Blends Investigations
EFFECT OF C12/OTHER FA BLENDS

| | | | Max | | |
|---|---|---|---|---|---|
| | Composition | Double | viscosity | | |
| Emulsifier | Comments | Bonds | (nominal) | Comments | FIG. |
| C12/Abietic Acid | | 0 and | n/a | The effect of blending | 24 |
| | | unsats | | abietic acid with C12 | |
| | | | | destroyed the v effect. | |
| C12: α-pinene | | 0 and | 100 | While an unsat, α-pinene | 25 |
| | | unsats | | does not affect viscosity | |
| C12:0 and B- | | 0 and | 85 | At increasing dosage, v | 26 |
| sitosterol | | unsats | | effect is reduced. Note that | |
| | | | | sitosterol is unsaponifiable | |
| C12:0 and a- | | 0 and | 110 | Tocopherol (vitamin E) | 27 |
| tocopherol | | unsats | | reduces the v effect. | |
| C12:0 and various a, | 14% α, 2% β (C₂₈H₄₈O₂), | 0 and | 90 | Tocopherol (vitamin E) | 28 |
| b, c, and d | 60% γ | unsats | | reduces the v effect. | |
| tocopherols | (C₂₈H₄₈O₂), 24% δ | | | | |
| | (C₂₇H₄₆O₂) | | | | |
| C12:0 and C18:3n3 | | 0 and 3 | 110 | UFA C18 reduces v effect. | 29 |
| cis | | unsats | | | |
| C12:0 and C20:5n3 | | 0 and 5 | 110 | UFA C18 reduces v effect. | 30 |
| | | unsats | | | |
| C12:0 and lanolin | Lanolin is a mixture | multiple | 90 | Reduces v effect | 31 |
| | of cholesterol and the | | | | |
| | esters of several fatty | | | | |
| | acids. | | | | |
| C12:0 and beeswax | Beeswax is a mixture | multiple | 90 | Reduces v effect | 32 |
| | of palmitate, | | | | |
| | palmitoleate, | | | | |
| | hydroxypalmitate[1] | | | | |
| | and oleate esters of | | | | |
| | long-chain (30-32 | | | | |
| | carbons) aliphatic | | | | |
| | alcohols. | | | | |

With reference to FIG. 24, the effect of increasing the amount of abietic acid relative to C12 saturated FA is shown. This experiment showed that relatively small quantities of abietic acid destroy the viscosity effect.

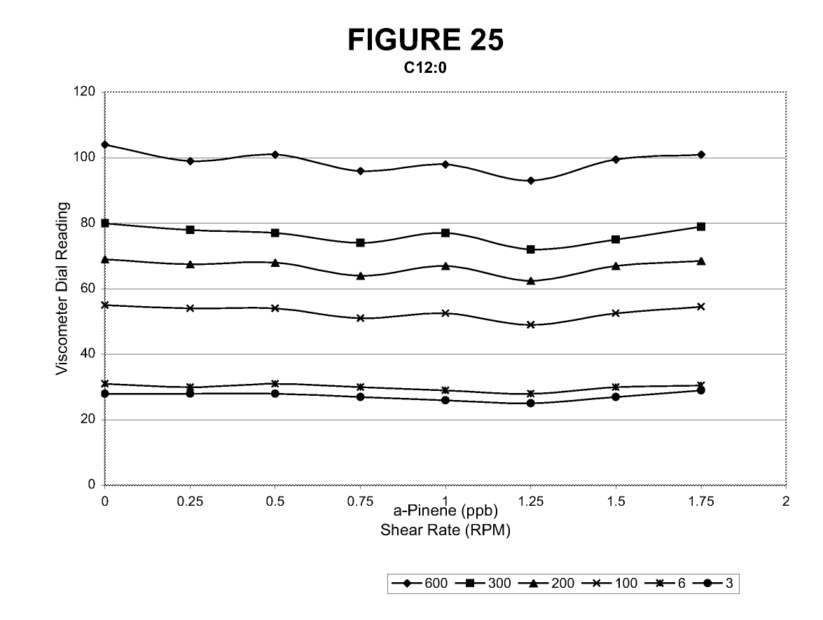

With reference to FIG. 25, the effect of increasing the amount of α-pinene relative to C12 saturated FA is shown. This experiment showed that α-pinene does not affect the viscosity effect.

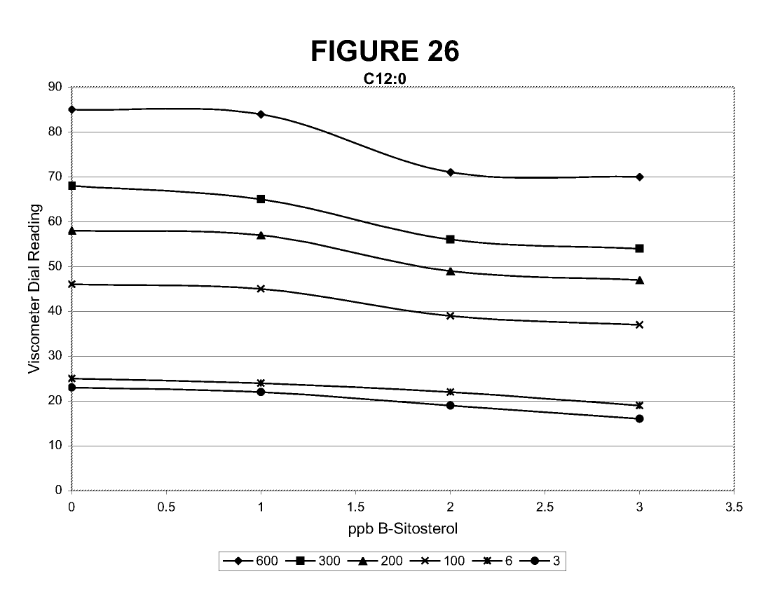

With reference to FIG. 26, the effect of increasing the amount of β-sitosterol relative to C12 saturated FA is shown. This experiment showed that β-sitosterol moderately reduced the viscosity effect as the amount of β-sitosterol was increased.

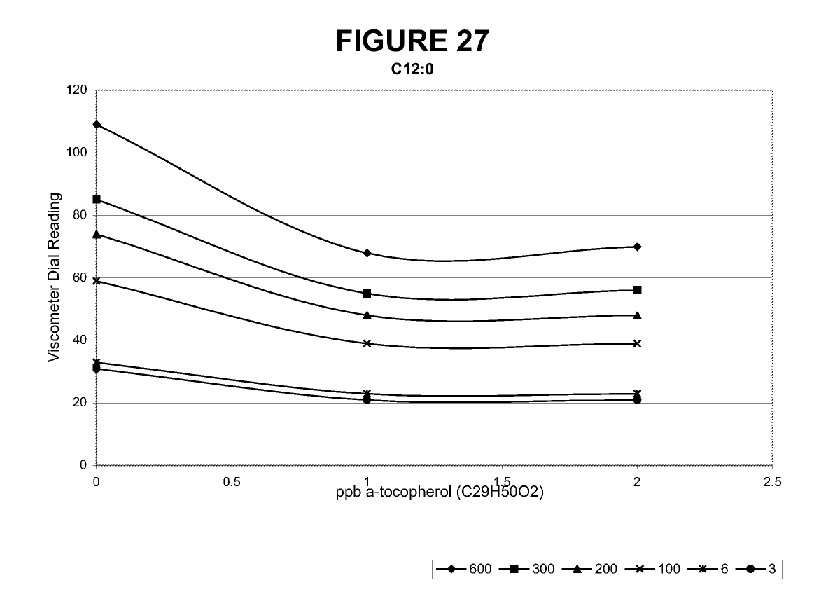

With reference to FIG. 27, the effect of increasing the amount of α-tocopherol relative to C12 saturated FA is shown. This experiment showed that α-tocopherol significantly reduced the viscosity effect as the amount of α-tocopherol was increased.

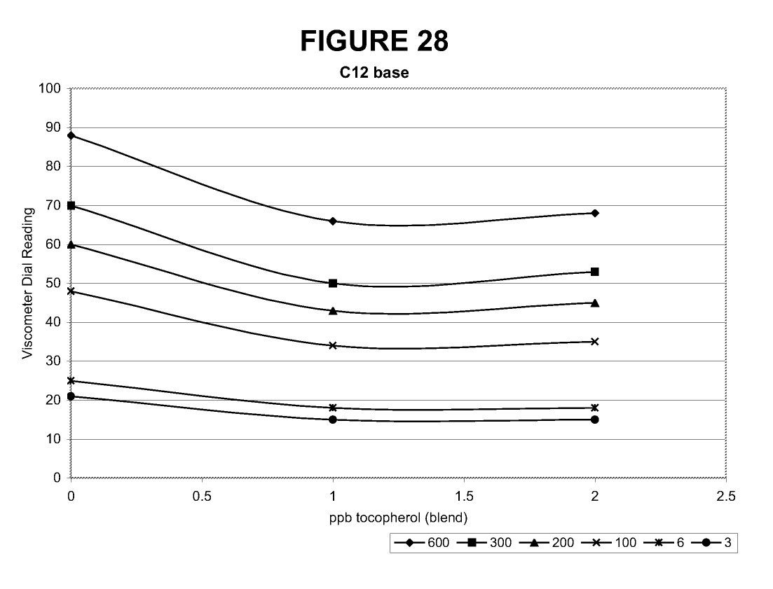

With reference to FIG. 28, the effect of increasing the amount of α-tocopherol relative to C12 saturated FA is shown. This experiment showed that α-tocopherol significantly reduced the viscosity effect as the amount of α-tocopherol was increased.

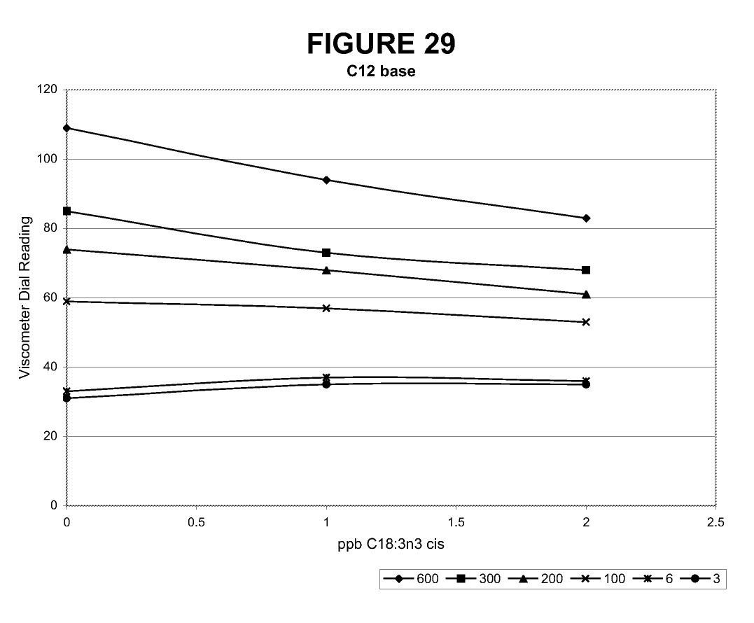

With reference to FIG. 29, the effect of increasing the amount of a highly unsaturated FA (C18:3n:3cis) relative to C12 saturated FA is shown. This experiment showed that the unsaturated FA significantly reduced the viscosity effect as the amount of the unsaturated FA was increased.

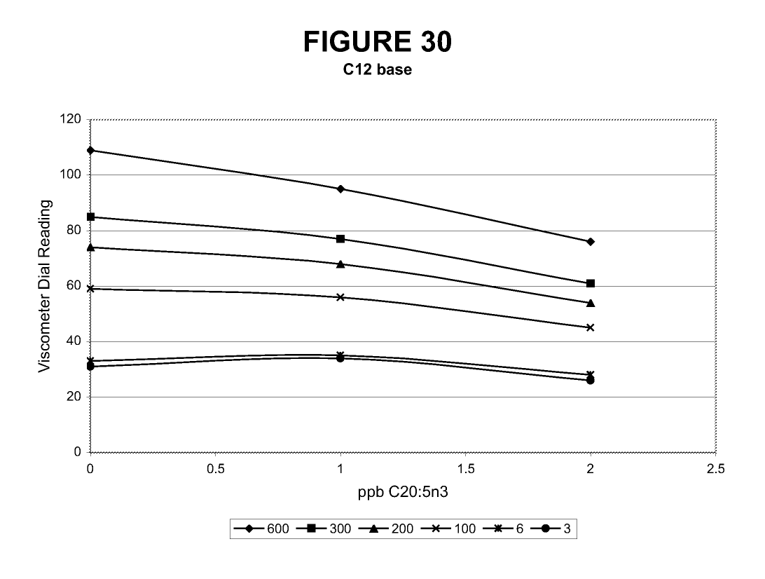

With reference to FIG. 30, the effect of increasing the amount of a highly unsaturated FA (C20:5n) relative to C12 saturated FA is shown. This experiment showed that the unsaturated FA significantly reduced the viscosity effect as the amount of the unsaturated FA was increased.

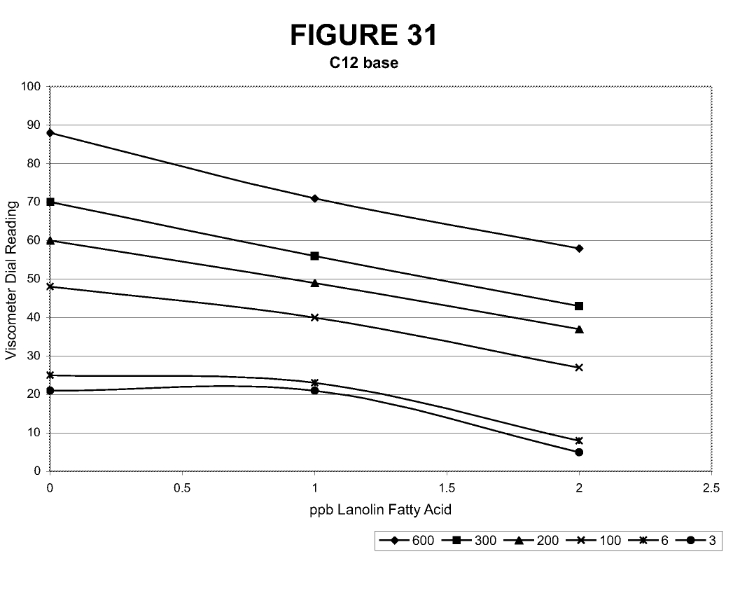

With reference to FIG. 31, the effect of increasing the amount of lanolin FA relative to C12 saturated FA is shown. This experiment showed that lanolin significantly reduced the viscosity effect as the amount of lanolin was increased.

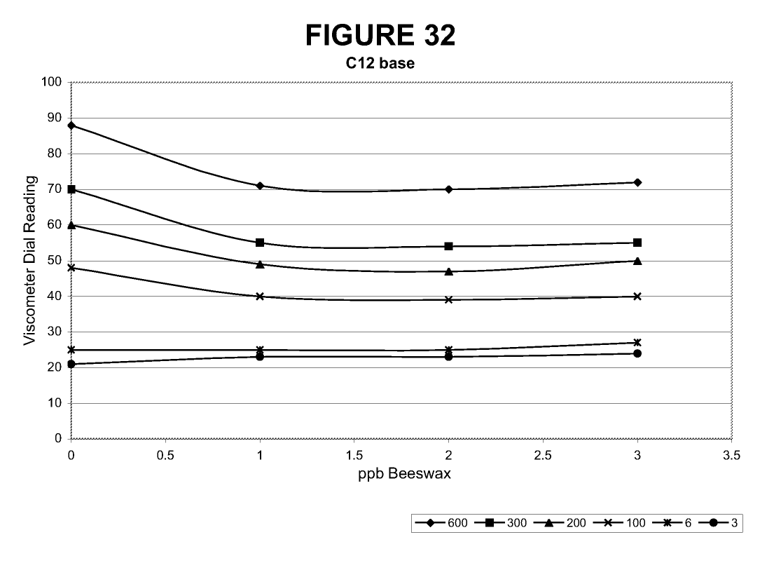

With reference to FIG. 32, the effect of increasing the amount of beeswax relative to C12 saturated FA is shown. This experiment showed that beeswax significantly reduced the viscosity effect as the amount of beeswax was increased.

### Seed, Plant and Other Oil Investigations

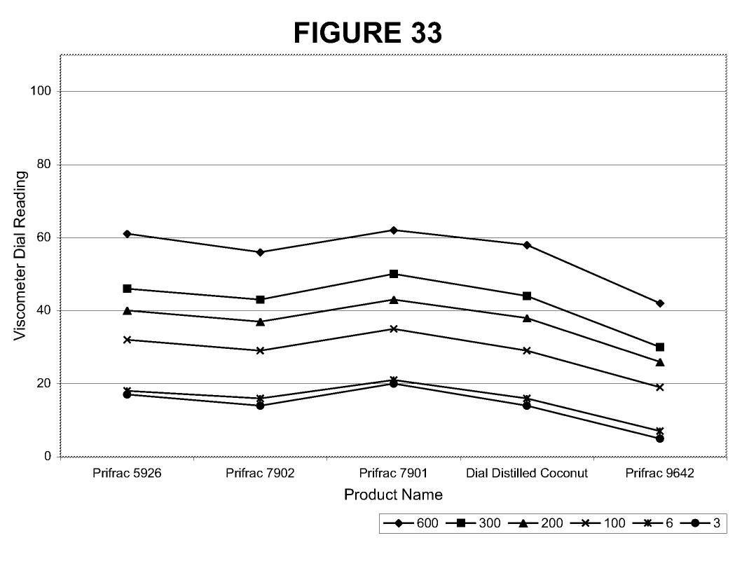

With reference to FIGS. 33-49 and Table 8, the effect of using various seed, plant and other oils as a primary emulsifier was investigated.

TABLE 11
Seed, Plant and Other Oil Investigations
VISCOSITY EFFECT OF INDIVIDUAL FAS

| | | | Max | | |
|---|---|---|---|---|---|
| | Composition | Double | viscosity | | |
| Emulsifier | Comments | Bonds | (nominal) | Comments | FIG. |
| Prifrac 5926 | Commercial | | 60 | Most coconut oil products | 33 |
| Prifrac 7902 | Products of Coconut | | | showed a significant v | |
| Prifrac 7902 | Oils. | | | effect at higher shear rates | |
| Dial Coconut Oil | ~94% SFAs | | | | |
| Prifrac 9642 | | | | | |
| Lanolin | Primarily a mixture | | 10 | No v effect | 34 |
| | of cholesterol and | | | | |
| | esters of FAs | | | | |
| | Blended with IMG | | | | |
| | 400 | | | | |
| Flax Seed Oil | Includes Linolenic | Multiple | 15 | No v effect | 35 |
| | acid (Omega 3 FA) | | | | |
| | Blended with IMG | | | | |
| | 400 | | | | |
| Canola Oil | Includes Linolenic | Multiple | 35 | Minor v effect | 36 |
| | acid (Omega 3 FA) | | | | |
| | Blended with IMG | | | | |
| | 400 | | | | |
| Safflower Oil | Includes Linoleic | Multiple | 20 | No v effect | 37 |
| | acid | | | | |
| | Blended with IMG | | | | |
| | 400 | | | | |
| Canola Oil | Blended with | Multiple | 80 | Low quality OC produces | 38 |
| | Bentone 920 | | | significant v effect | |
| Safflower Oil | Blended with | Multiple | 15 | No v effect | 39 |
| | Bentone 920 | | | | |
| Canola Oil | Blended with | Multiple | 42 | Low quality OC produces | 40 |
| | Claytone II | | | minor v effect | |
| Distilled Coconut | Blended with IMG | minor | 250 | Very significant v effect | 41 |
| Oil | 400 | | | | |
| Olive Oil | Primarily mono and | Multiple | 60 | Significant v effect occurs | 42 |
| | poly unsats | | | | |
| | Blended with IMG | | | | |
| | 400 | | | | |
| Myristic Acid | C14 | none | 140 | Very significant v effect | 43 |
| (derived from palm | Blended with IMG | | | | |
| oil) | 400 | | | | |
| Peanut Oil | (contains palmitic | 1 in | 30 | Minor v effect | 44 |
| | acid (C16:0) and | oleic | | | |
| | oleic acid (C18:1) | acid | | | |
| | inter alia) | | | | |
| | Blended with IMG | | | | |
| | 400 | | | | |
| Cottonseed oil | Linoleic (C18:2n) | 2 | 28 | Minor v effect | 45 |
| (contains palmitc, | Blended with IMG | (linoleic | | | |
| oleic and linoleic | 400 | acid) | | | |
| acid) | | | | | |
| Uniqema Prifrac | Blended with IMG | minor | 260 | Very significant v effect | 46 |
| 5926 Coconut FA | 400 | | | | |
| Red Palm Oil | 50:50 Sat:Unsat | yes | 68 | Significant V effect | 47 |
| | Blended with with | | | | |
| | IMG 400 | | | | |
| Palm Kernal Oil | 50:50 Sat:Unsat | yes | 80 | Significant v effect | 48 |
| | Blended with | | | | |
| | Bentone 920 | | | | |
| Distilled Tallow | 40:60 Sat:Unsat | yes | 130 | Very significant V effect | 49 |
| | Blended with | | | | |
| | Bentone 920 | | | | |

With reference to FIG. 33, the viscosity effect of different commercial coconut oils is compared. The graph shows a significant viscosity effect for each coconut oil at high shear rates.

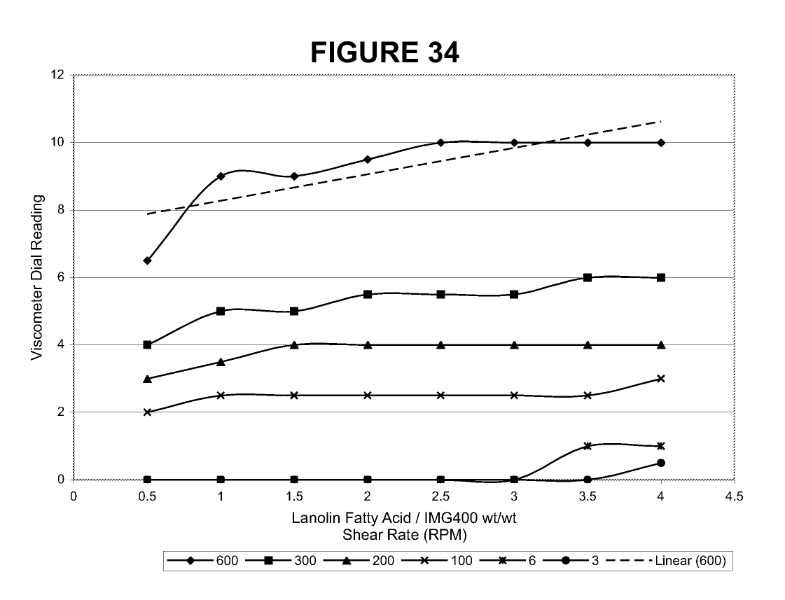

With reference to FIG. 34, the effect of lanolin as a primary emulsifier is shown. No viscosity effect is observed with this FA.

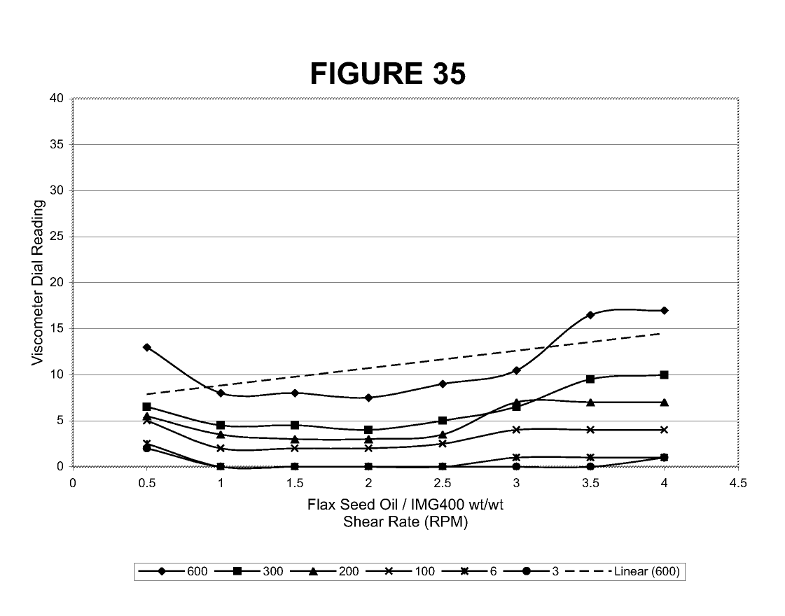

With reference to FIG. 35, the effect of flax seed oil as a primary emulsifier is shown. No viscosity effect is observed with this oil.

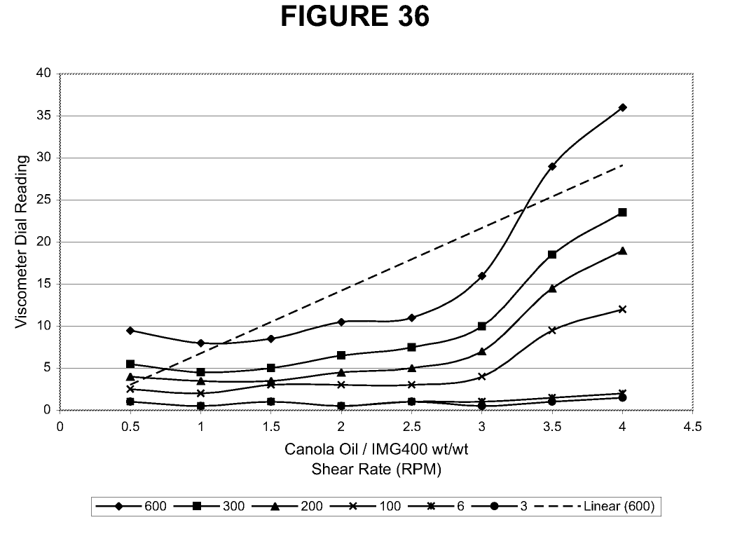

With reference to FIG. 36, the effect of canola oil as a primary emulsifier is shown. A minor viscosity effect is observed with this oil at concentrations above 3.5 at higher shear rates.

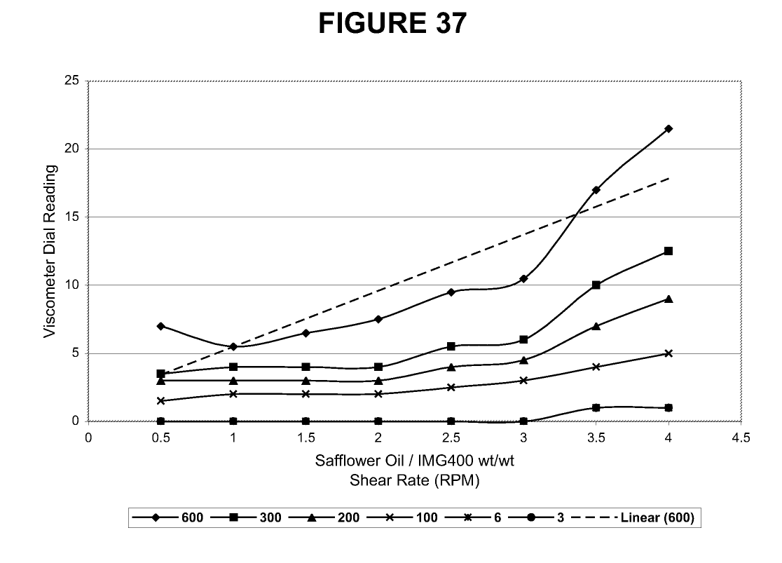

With reference to FIG. 37, the effect of safflower oil as a primary emulsifier is shown. No viscosity effect is observed with this oil.

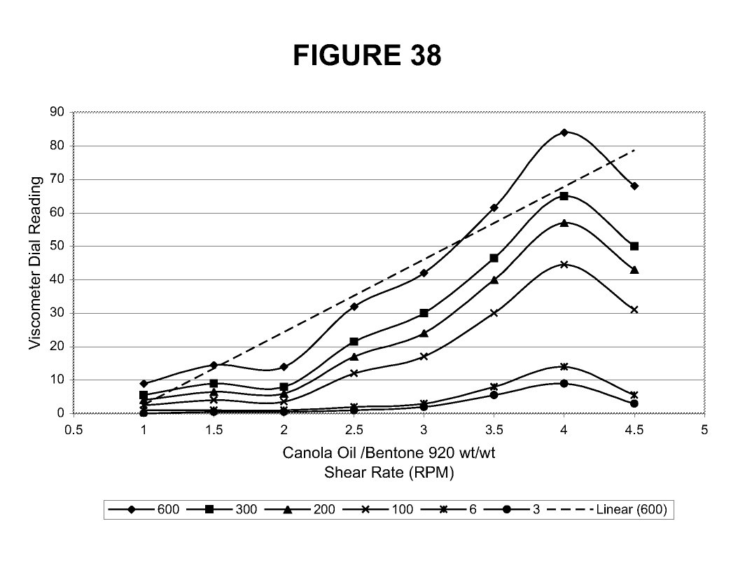

With reference to FIG. 38, the effect of canola oil as a primary emulsifier is shown with a lower quality OC. A significant viscosity effect is observed with this oil at concentrations above 3.0 at higher shear rates.

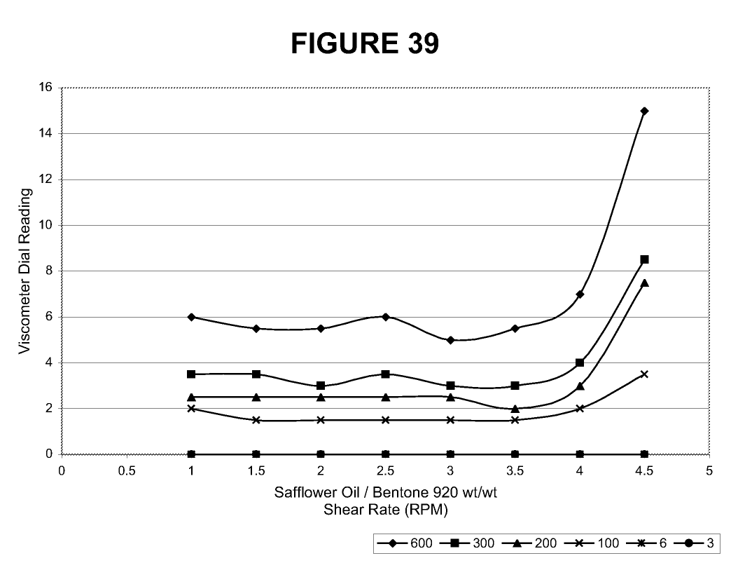

With reference to FIG. 39, the effect of safflower oil as a primary emulsifier is shown with a lower quality OC. No viscosity effect is observed with this oil.

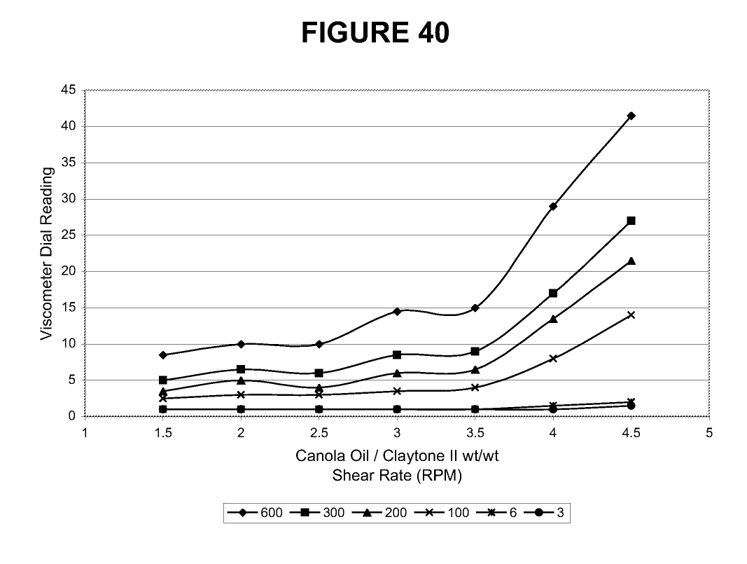

With reference to FIG. 40, the effect of canola oil as a primary emulsifier is shown with a lower quality OC. A minor viscosity effect is observed with this oil at concentrations above 4.0 at higher shear rates.

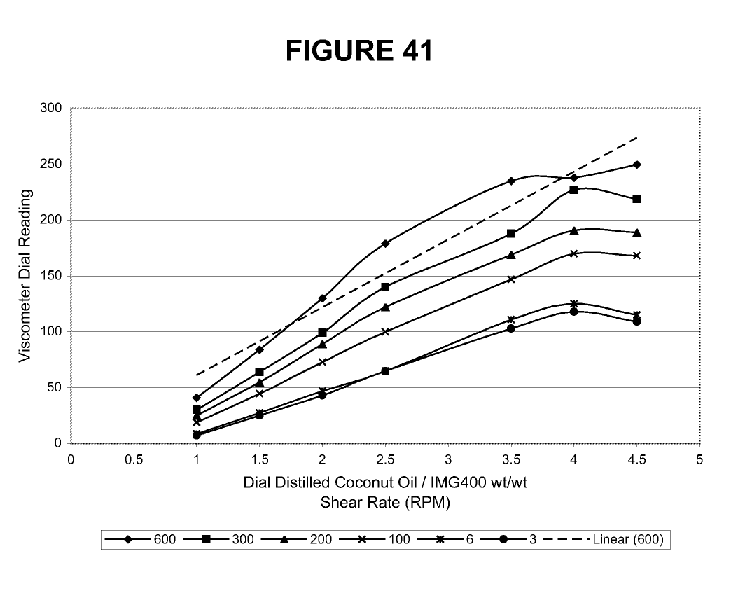

With reference to FIG. 41, the effect of a commercial coconut oil as a primary emulsifier is shown. A very significant viscosity effect is observed with this oil at concentrations above 2.0 at middle-range and higher shear rates. The peak viscosity is 250 at a concentration of 4.0.

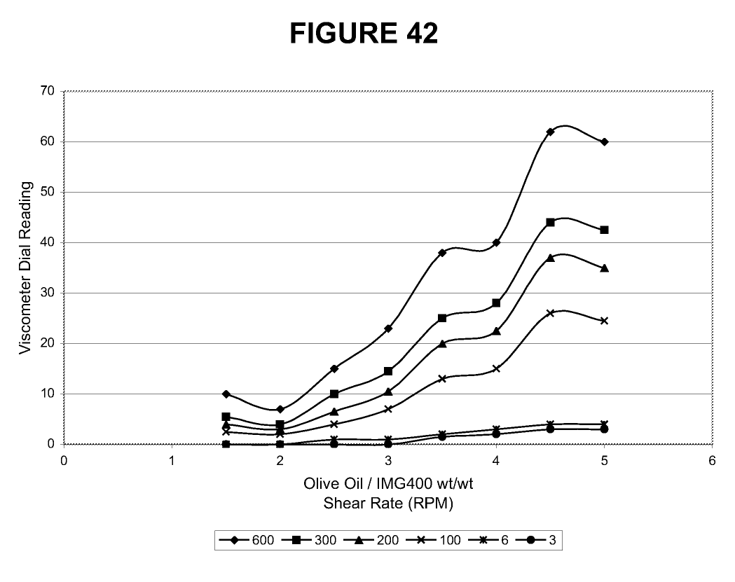

With reference to FIG. 42, the effect of olive oil as a primary emulsifier is shown. A significant viscosity effect is observed with this oil at concentrations above 4.0 at higher shear rates.

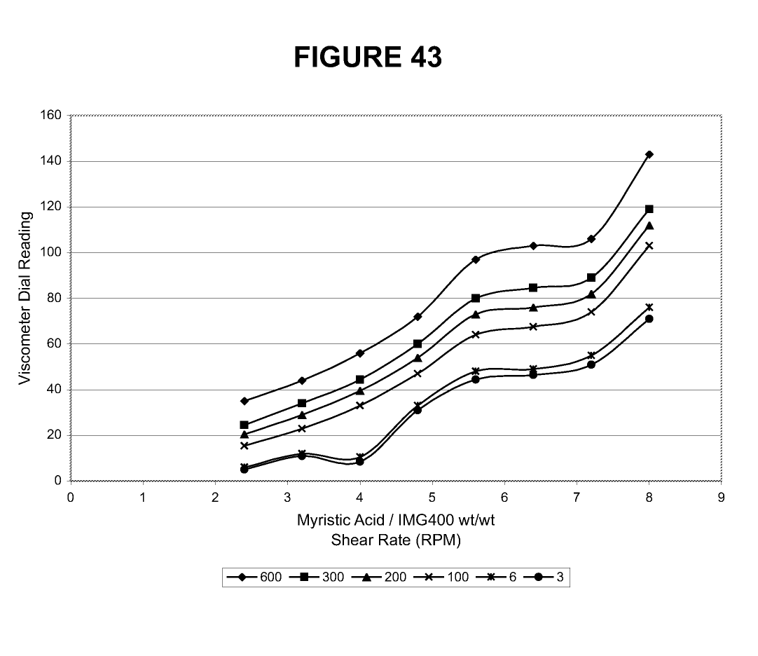

With reference to FIG. 43, the effect of myristic acid as a primary emulsifier is shown. A very significant viscosity effect is observed with this FA at concentrations above 6 at higher shear rates and a significant viscosity effect at concentrations above 4 at both middle-range and higher shear rates.

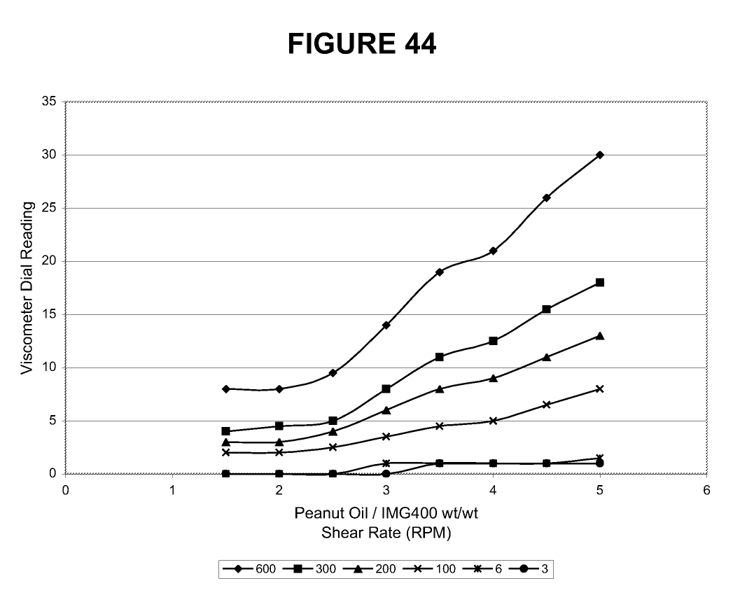

With reference to FIG. 44, the effect of peanut oil as a primary emulsifier is shown. A minor viscosity effect is observed with this oil at concentrations above 4.0 at higher shear rates.

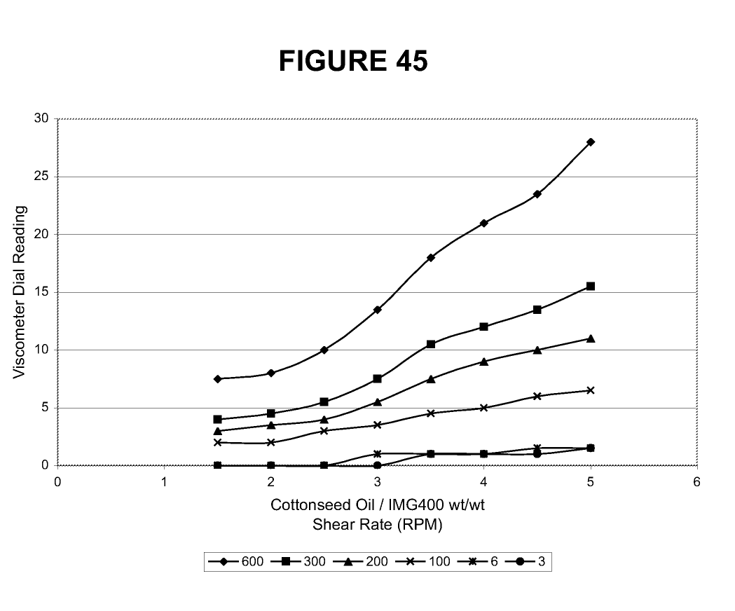

With reference to FIG. 45, the effect of cottonseed oil as a primary emulsifier is shown. A minor viscosity effect is observed with this oil at concentrations above 4.0 at higher shear rates.

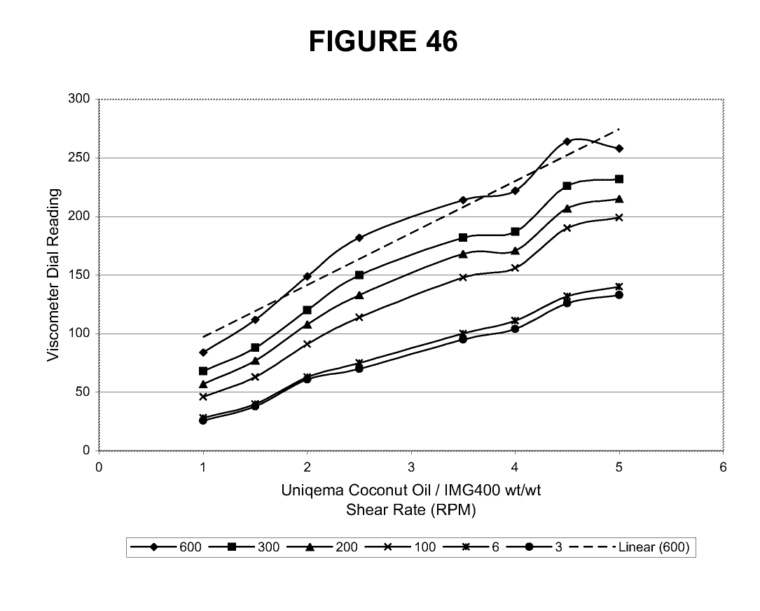

With reference to FIG. 46, the effect of a commercial coconut oil as a primary emulsifier is shown. A very significant viscosity effect is observed for this oil at concentrations above 2.0 at both the middle-range and higher shear rates. A significant viscosity effect is observed for this oil at concentrations above 1.0 at both the middle-range and higher shear rates. Peak viscosity with this oil is observed to be approximately 260.

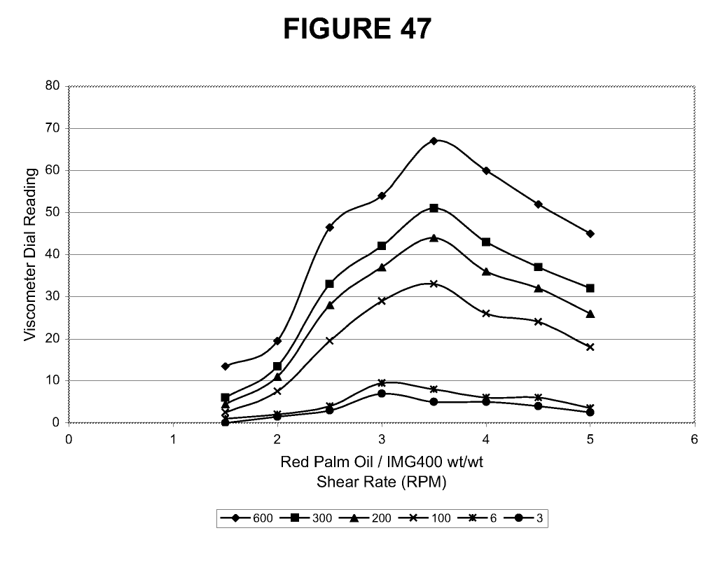

With reference to FIG. 47, the effect of red palm oil as a primary emulsifier is shown. A significant viscosity effect is observed with this oil at concentrations in the range of 3-4.5 at higher shear rates and at concentrations of 3-4 for middle-range shear rates.

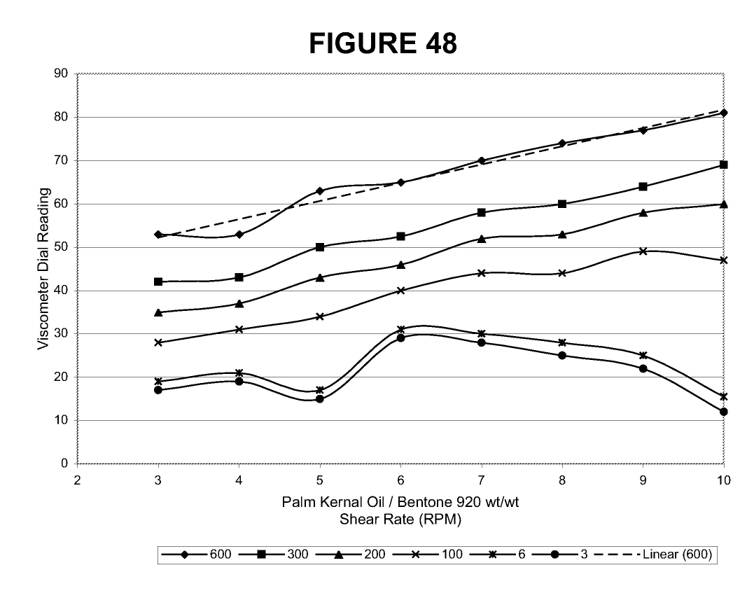

With reference to FIG. 48, the effect of palm kernal oil as a primary emulsifier is shown and a lower quality OC. A significant viscosity effect is observed with this oil at concentrations above 3.0 at both the middle-range and higher shear rates.

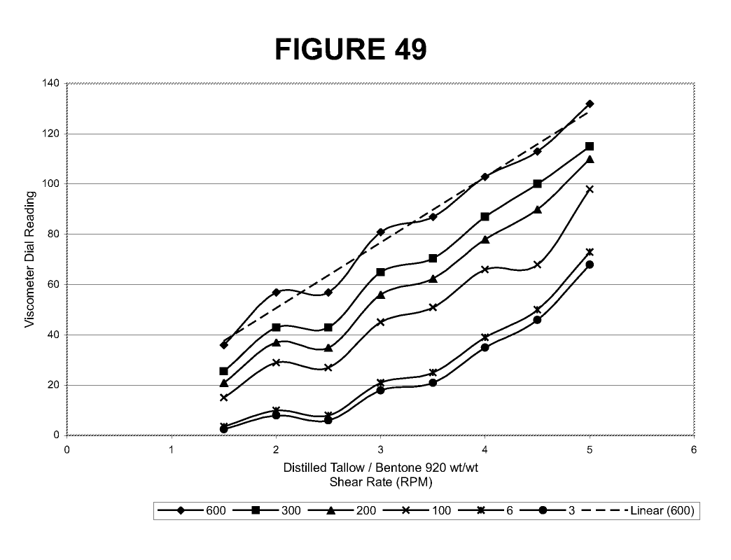

With reference to FIG. 49, the effect of distilled tallow oil as a primary emulsifier is shown with a lower quality OC. A very significant viscosity effect is observed with this oil at concentrations above 4.0 at higher shear rates. A significant viscosity effect is observed with this oil at concentrations above 2.0 for the middle-range shear rates.

In summary, various plant oils, and in particular, various coconut oils produced very significant viscosity effects. Correlation between the presence of unsaturated chains and the viscosity effect was not observed. The use of lower quality OCs appeared to produce superior viscosity effects.

### Emulsion Stability Investigations

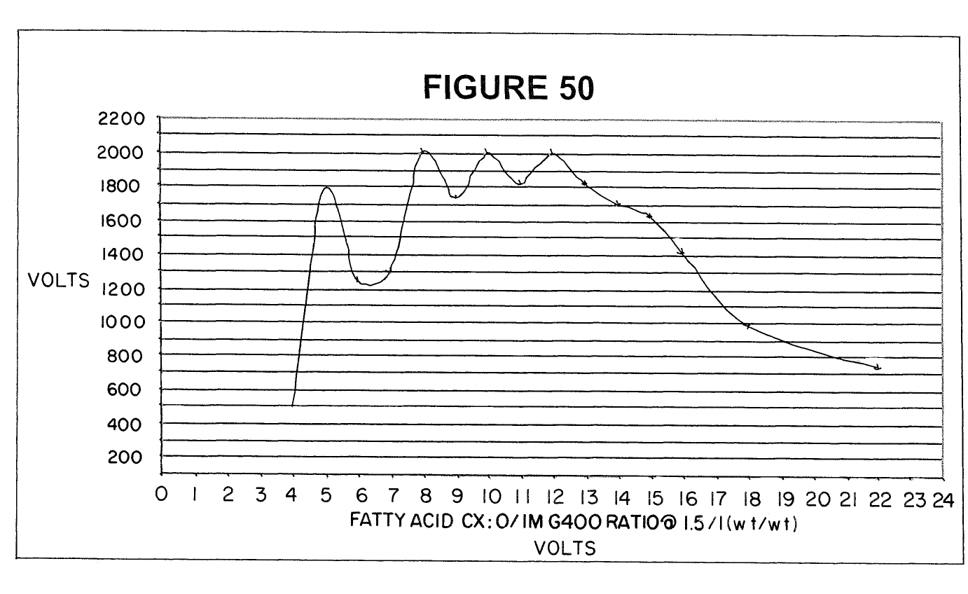

With reference to FIG. 50, the emulsion stability of various emulsions prepared with C4-C22 saturated fatty acids as emulsifier are compared.

As compared to the emulsion stability of a similar emulsion prepared using the baseline CTOFAs (Table 12) as emulsifier, it can be seen that the emulsion stability is higher when an SFA is used as an emulsifier.

TABLE 12
Emulsion Stability CTOFAs

| | CTOFA (wt/wt) | | | | | | | |
|---|---|---|---|---|---|---|---|---|
| | 0.5 | 1 | 1.5 | 2 | 2.5 | 3 | 3.5 | 4 |
| Volts | 428 | 384 | 487 | 440 | 469 | 465 | 378 | 373 |

### Discussion of Molecular Structures

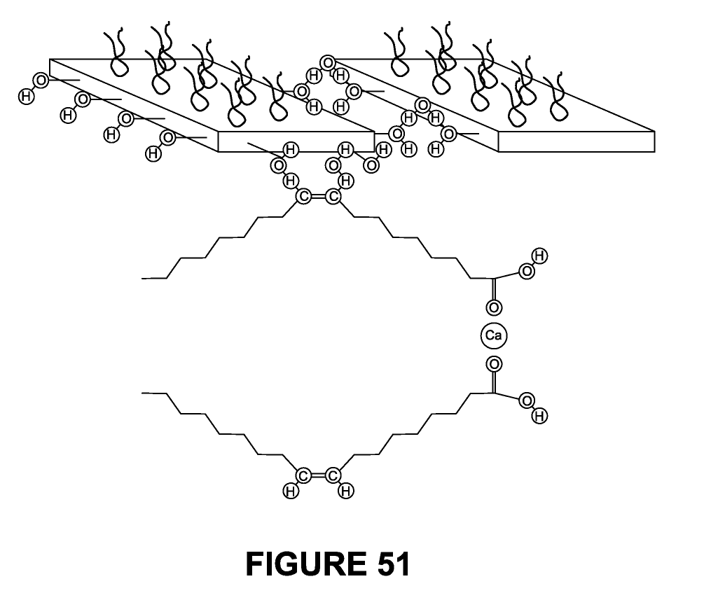

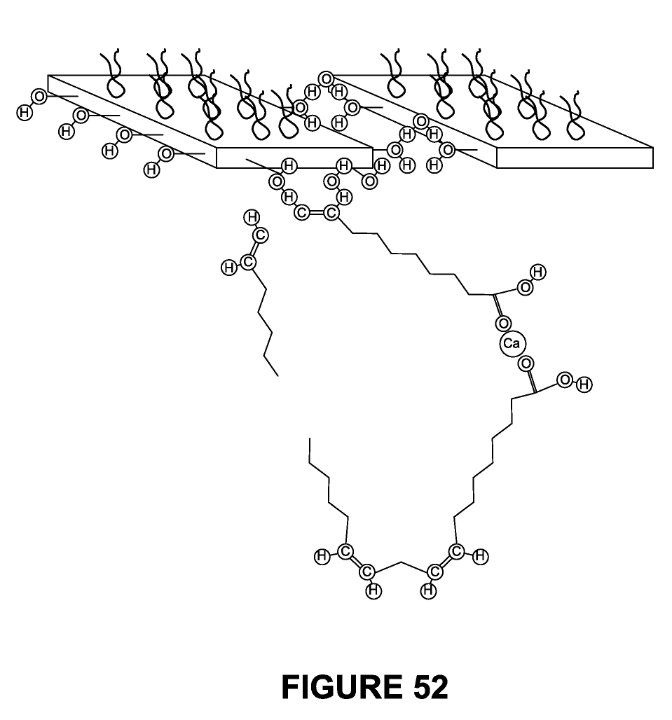

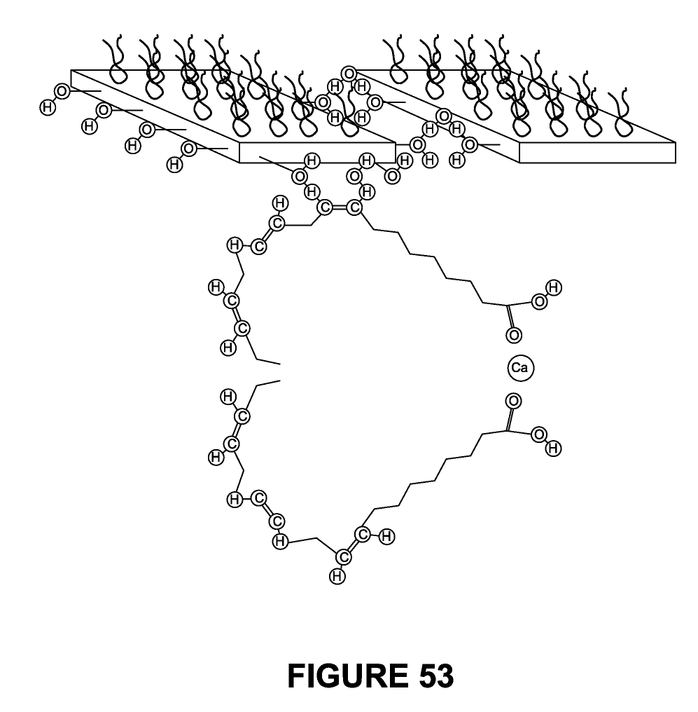

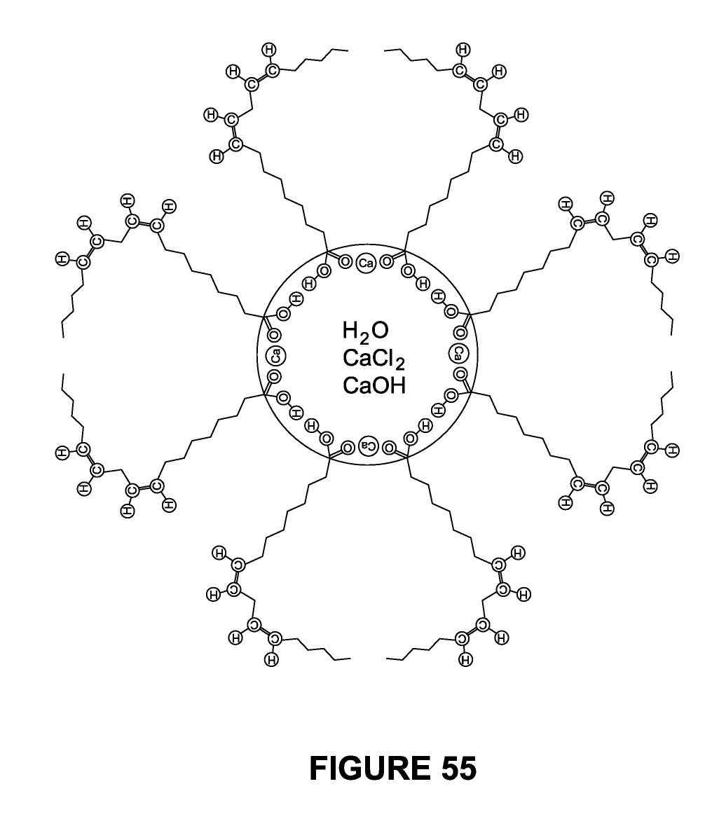

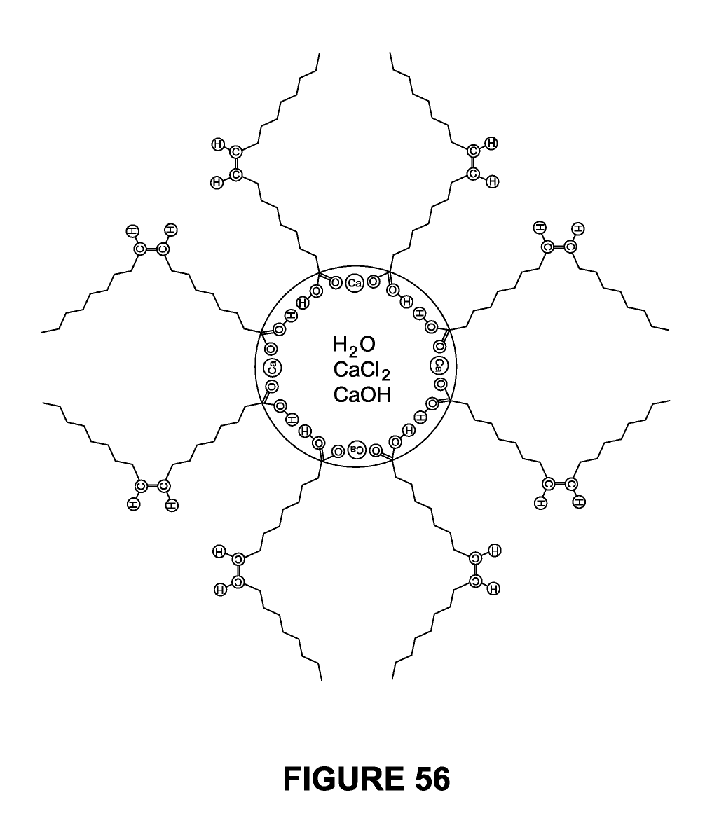

With reference to FIGS. 51-58, the molecular structures of the compounds within an oil/water/OC emulsion are shown schematically. The molecular structures suggest that the availability of free hydrogen bonding sites on the organophilic clay is important in the emulsion's ability to produce viscosity. It is believed that preventing or minimizing the opportunity for H₂O to provide edge-edge bonding at the OH⁻ sites on the edges of the organophilic clay affects the viscosity in an oil/water emulsion. The organophilic clay is depicted as a platelet structure with associated quarternary amine salts to a typical saturation on the outer surface of the clay particle. A number of outer OH— groups on the edges of the OC platelets may hydrogen bond with adjacent OH— groups on adjacent OC platelets.

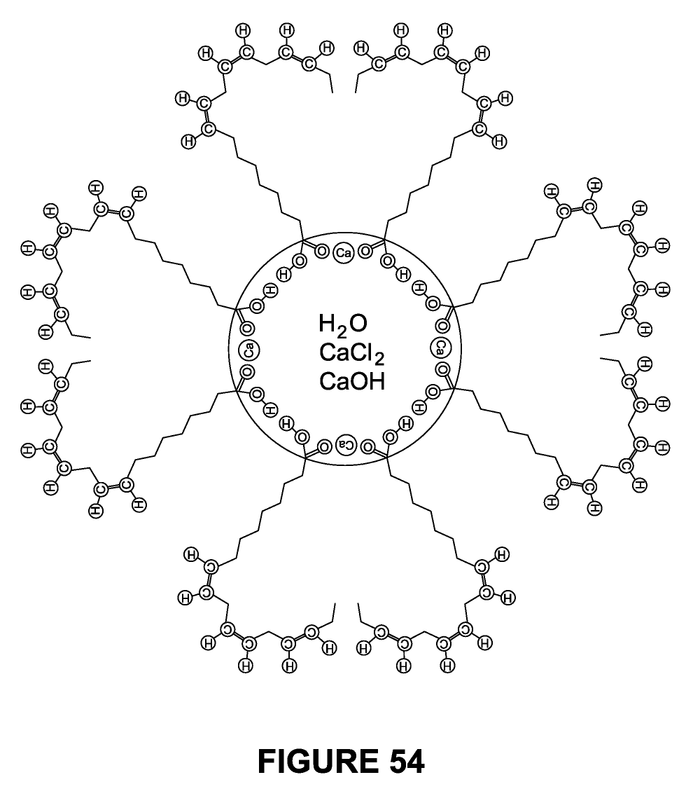

FIGS. 51-53 more specifically show the effect of increasing unsaturation on the interaction of UFAs with a clay platelet. FIGS. 54-56 show the interaction of UFAs with a water droplet. It is understood that the double bonds of the UFAs create localized charge that may hydrogen bond with the platelet OH— groups that together with any stearic effects may further affect the ability of clay particles to hydrogen bond with one another. The partial interference of the UFAs with the platelet's edge to edge bonding is believed to be the mechanism for interfering with the emulsion's ability to produce viscosity. Similarly, stearic effects may affect the UFAs ability to interface with water droplet.

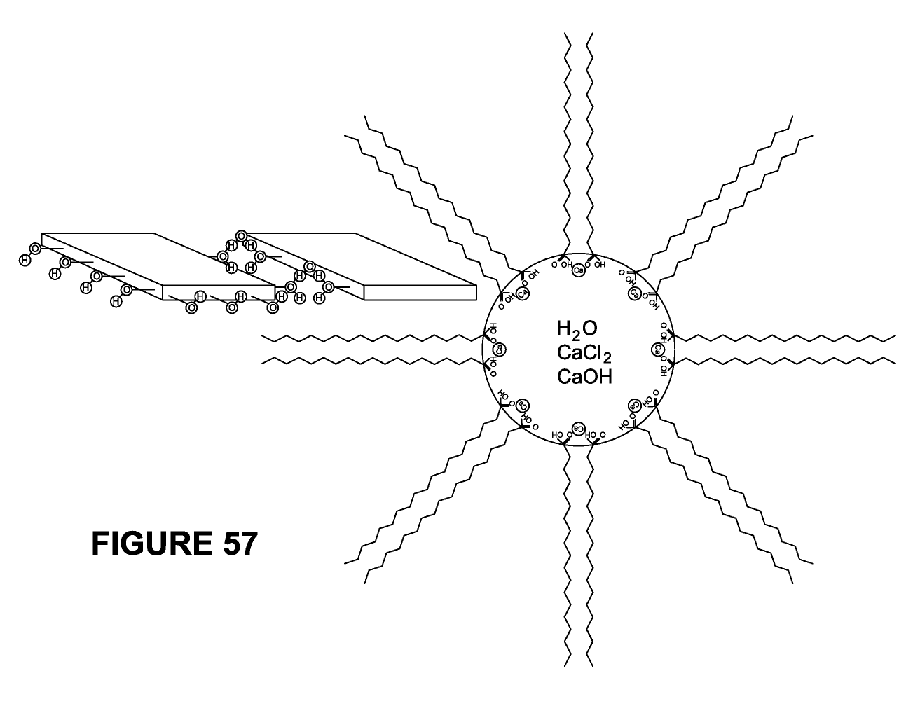

FIG. 57 is schematic representation of a SFA and its interaction with a water droplet. As the SFA will effectively only interact with the quarternary amines of the platelets and the water droplet such that the hydrophobic tails of both the quarternary amines and SFA will entangle without stearic effects, this is believed to be the mechanism for improved viscosity and emulsion stability effects.

### Clay Performance

The data indicates that the performance of lower quality clays including IMG400, Bentone 920, Claytone 3, were all capable of providing equivalent viscosification compared to the higher priced OCs including Bentone 150 and Claytone EM. This observation indicates that less organophilic clay would be required to prepare products having a desired viscosity. In addition, the cost of the clay required for such products would be less.

In addition, the data indicates that for a given amount of organophilic clay, the selection of emulsifier or blend of emulsifier can be used to effectively increase the viscosity of the emulsion, and thus improve the “performance” of the organophilic clay. Thus, by understanding the effectiveness of certain emulsifiers in their ability to improve OC performance, compositions having desired properties can be tailored by adjusting the level of viscosity enhancing emulsifiers (such as a C12 SFA) or blends of various emulsifiers. Practically, the amounts of organophilic clay and emulsifier are balanced to minimize the amount of organophilic clay for a desired viscosity and the amount of emulsifier is sequentially increased to produce the desired viscosity.

### Applications

### Drilling Fluids

Specifically, the emulsion stabilizing properties provided by the SFAs may be used to enhance the properties of oil well drilling fluids. Generally, blends of UFAs have been used in the past in organic solutions used for oil well drilling. As noted above, one of the challenges associated with oil well drilling is the need to reduce the amount of the drilling fluid utilized because of viscosity breakdown issues. In addition, there is a need to control oil-wetting of in-well compounds, such as drill cuttings, by hydrogen bonding between various in-well compounds and the emulsifiers.

The use of SFAs as an emulsifier allows the operator to effectively create drilling fluid compositions that minimizes organophilic clay consumption and allows superior control over viscosity and emulsion stability. As a result, methods and compositions in accordance with the invention reduces the amount of oil based drilling fluid that would adhere to in-well compounds, thus reducing losses of the oil based drilling fluids (lower operator cost) as well as reducing the environmental impact and cost associated with the disposal of contaminated in-well compounds such as drill cuttings, as is necessary.

### Field Trial Data

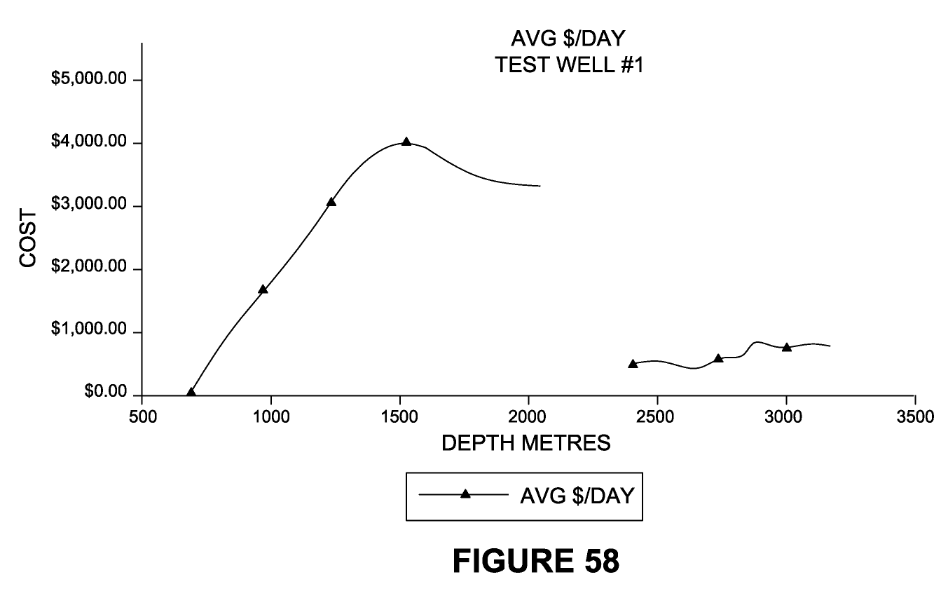

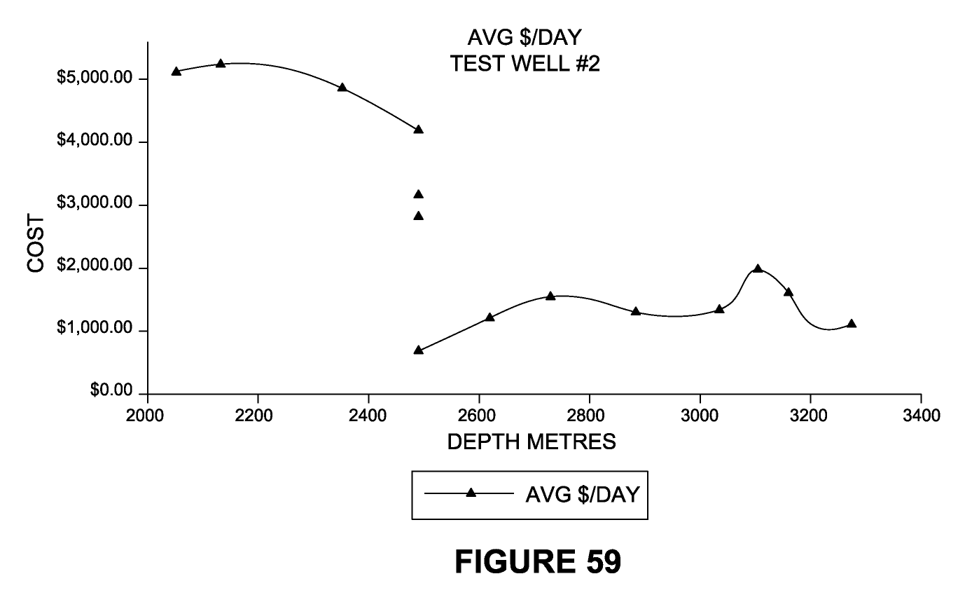

Field trials were conducted to determine if the costs associated with an oil based drilling fluid program could be reduced with compositions in accordance with the invention. A representative field trial (FIGS. 58 and 59) was conducted in two stages. In stage 1, test wells 1 and 2 were initiated with a drilling fluid system based on the use of CTOFA emulsifiers. At casing point, this system was replaced with an oil based drilling fluid incorporating Bentone 920/crushed canola seed (primary emulsifier)/lauric acid (secondary emulsifier).

Upon the introduction of the drilling fluid prepared in accordance with the invention, both wells saw a dramatic collapse of costs with the daily maintenance costs for drilling fluid. Costs fell on both wells from roughly $4000/day to approximately $1000/day (or better), a reduction of around 75%. Subsequent wells were all started with the Applicant's drilling fluid and in each case they were able to maintain the low daily cost averages attained in Test Wells #1 and #2.

### Other Applications

Organophilic clay solutions containing saturated fatty acids may be used in various products such as industrial chemicals, greases and cosmetics where it may be desirable to improve the performance of organophilic clays and/or control the viscosity/emulsion stability of the composition. More specifically, such applications may include lubricating greases, oil base packer fluids, paint-varnish-lacquer removers, paints, foundry molding sand binders, adhesives and sealants, inks, polyester laminating resins, polyester gel coats, cosmetics, detergents, and the like.

It is understood that the foregoing description includes examples that illustrate the concepts of the invention and that such examples are not intended to be limiting to the scope of the invention as understood by one skilled in the art.

1. A method for controlling the viscosity of an oil and water emulsion comprising the step of introducing an effective amount of an emulsifier to an oil and water emulsion containing organophilic clay (OC) to produce a desired viscosity in the emulsion wherein the emulsifier is selected from any one of:
a. any one of a C8-C18 saturated fatty acid (SFA);
b. a blend of two or more different C8-C18 SFAs;
c. a blend of a C8-C18 SFA and at least one 2-5n unsaturated fatty acid (UFA);
d. a vegetable oil selected from any one of safflower oil, olive oil, cottonseed oil, coconut oil, peanut oil, palm oil, palm kernel oil, and canola oil; and
e. tallow oil.

2. The method of claim 1 wherein the amount of emulsifier and organophilic clay are selected to maximize the performance of the organophilic clay for the desired viscosity.

3. The method of claim 1 wherein the amounts of organophilic clay and emulsifier are balanced to minimize the amount of organophilic clay for a desired viscosity and the amount of emulsifier is sequentially increased to produce the desired viscosity.

4. The method of claim 1 further comprising the step of blending an effective amount of any one of or a combination of an unsaturated fatty acid, resin acid, lanolin, tocopherols, beeswax, flax oil, or fish oil to reduce the viscosity of the emulsion.

5. The method of claim 4 wherein the resin acid is abietic acid.

6. A method for controlling the viscosity of an oil and water emulsion comprising the step of introducing an effective amount of an emulsifier to an oil and water emulsion containing organophilic clay (OC) to produce a desired viscosity in the emulsion wherein the emulsifier is a blend of a C8-C18 saturated fatty acid (SFA) and at least one unsaturated fatty acid (UFA) and the ratio of SFA to UFA is adjusted to produce the desired viscosity.

7. A method for producing a hydrocarbon/water/organophilic clay emulsion having a desired viscosity comprising the steps of:
a) blending a hydrocarbon continuous phase and a water dispersed phase together with an organophilic clay; and,
b) introducing an effective amount of an emulsifier the emulsifier selected from any one of:
i. any one of a C8-C18 saturated fatty acid (SFA);
ii. a blend of two or more different C8-C18 SFAs;
iii. a blend of a C8-C18 SFA and at least one 2-5n unsaturated fatty acid (UFA);
iv. a vegetable oil selected from any one of safflower oil, olive oil, cottonseed oil, coconut oil, peanut oil, palm oil, palm kernel oil, and canola oil; and
v. tallow oil.

8. The method of claim 7 wherein the desired viscosity is obtained by minimizing the amount of organophilic clay and increasing the amount of emulsifier to produce the desired viscosity.

9. A method of controlling the emulsion stability of an oil and water emulsion comprising the steps of introducing an effective amount of an emulsifier to an oil and water emulsion containing organophilic clay (OC) to produce a desired emulsion stability in the emulsion wherein the emulsifier is a C8-C18 saturated fatty acid (SFA) and at least one an unsaturated fatty acid (UFA) and the ratio of SFA to UFA is adjusted to produce the desired emulsion stability.

10. A method of increasing the emulsion stability of an oil and water emulsion comprising the step of introducing an effective amount of a C8-C18 saturated fatty acid (SFA) emulsifier to an oil and water emulsion containing organophilic clay (OC).

11. A method of increasing the oil-wetting properties of an oil and water emulsion comprising the step of introducing an effective amount of at least one unsaturated fatty acid (UFA) emulsifier to an oil and water emulsion containing organophilic clay (OC).

12. A hydrocarbon/water/organophilic clay composition having a desired viscosity comprising:
a hydrocarbon continuous phase;
a water dispersed phase;
an organophilic clay; and,
an emulsifier, the emulsifier selected from:
i. any one of a C8-C18 saturated fatty acid (SFA);
ii. a blend of two or more different C8-C18 SFAs;
iii. a blend of a C8-C18 SFA and at least one 2-5n unsaturated fatty acid (UFA);
iv. a vegetable oil selected from any one of safflower oil, olive oil, cottonseed oil, coconut oil, peanut oil, palm oil, palm kernel oil, and canola oil; and
v. tallow oil.
wherein the amounts of organophilic clay and emulsifier are selected to maximize the performance of the organophilic clay for the desired viscosity of the composition.

13. The composition of claim 12 wherein the emulsifier is selected to maximize organophilic clay performance and to produce a desired viscosity.

14. The composition of claim 12 wherein the organophilic clay is selected from any one of or a combination of a wet-process or dry-process clay.

15. The composition of claim 12 wherein the emulsion has an emulsion stability greater than 500 volts.

16. A drilling fluid composition comprising
a hydrocarbon continuous phase;
a water dispersed phase;
an organophilic clay; and,
an emulsifier, the emulsifier selected from
i. any one of a C8-C18 saturated fatty acid (SFA);
ii. a blend of two or more different C8-C18 SFAs;
iii. a blend of a C8-C18 SFA and at least one 2-5n unsaturated fatty acid (UFA);
iv. a vegetable oil selected from any one of safflower oil, olive oil, cottonseed oil, coconut oil, peanut oil, palm oil, palm kernel oil, and canola oil; and
v. tallow oil.

17. The composition of claim 16 wherein the hydrocarbon:water ratio is 1:1 to 99:1 (v/v).

18. The composition of claim 16 wherein the emulsifier is selected to maximize organophilic clay performance to produce a desired viscosity.

19. The composition of claim 16 wherein the organophilic clay is selected from any one of or a combination of a wet-process or dry-process clay.

20. The composition of claim 16 wherein the emulsion has an emulsion stability greater than 500 volts.

21. A method for drilling a wellbore comprising the steps of:
a. operating a drilling assembly to drill a wellbore; and
b. circulating an oil-based drilling fluid through the wellbore, the oil-based drilling fluid comprising:
i. a hydrocarbon continuous phase;
ii. a water dispersed phase;
iii. an organophilic clay; and,
iv. an emulsifier, the emulsifier selected from
1. any one of a C8-C18 saturated fatty acid (SFA);
2. a blend of two or more different C8-C18 SFAs;
3. a blend of a C8-C18 SFA and at least one 2-5n unsaturated fatty acid (UFA);
4. a vegetable oil selected from any one of safflower oil, olive oil, cottonseed oil, coconut oil, peanut oil, palm oil, palm kernel oil, and canola oil; and
5. tallow oil.

22. The method of claim 21 further comprising either before or during step b, adjusting the viscosity of the drilling fluid by adding additional emulsifier to increase the viscosity of the drilling fluid or adding an effective amount of any one of or a combination of an unsaturated fatty acid, resin acid, lanolin, tocopherols, beeswax, flax oil, or fish oil to reduce the viscosity of the emulsion.
